(19) United States
(12) Patent Application Publication
(10) Pub. No.: US 2013/0231088 A1
(43) Pub. Date: Sep. 5, 2013

(54) SYSTEM AND METHOD FOR SOCIAL PROFILING USING WIRELESS COMMUNICATION DEVICES

(71) Applicant: E3, LLC, Newport Beach, CA (US)

(72) Inventors: Gary B. Jabara, Irvine, CA (US); Lloyd Frederick Linder, Agoura Hills, CA (US); David Brett Simon, Agoura Hills, CA (US)

(73) Assignee: E3, LLC, Newport Beach, CA (US)

(21) Appl. No.: 13/769,053

(22) Filed: Feb. 15, 2013

Related U.S. Application Data
(63) Continuation-in-part of application No. 13/093,998, filed on Apr. 26, 2011.
Application No. 13/093,998 is a continuation-in-part of application No. 12/958,296, filed on Dec. 1, 2010.
Application No. 12/958,296 is a continuation-in-part of application No. 12/616,958, filed on Nov. 12, 2009, now Pat. No. 8,190,119.
Application No. 12/616,958 is a continuation-in-part of application No. 12/397,225, filed on Mar. 3, 2009, now Pat. No. 7,970,351.

(51) Int. Cl. H04W 4/00

(52) U.S. Cl. CPC H04W 4/008
USPC 455/411

(57) ABSTRACT

A wireless network is established by direct communication between a user equipment (UE) and wireless access points within a venue. After initial registration, the UE may be automatically authenticated upon entry into the venue. In the venue, the UE sends a periodic signal that includes information from which the UE location within the venue may be determined. The system can develop a social profile based on how “social” the user of the UE is on the network by analyzing message data between users of the network. The analysis and social profile generation can be used to identify users that are the most social. In addition, the analysis can develop a social DNA rating based on various factors, including the number and types of messages sent and received, sent messages that get a response, and the number of pictures, files and push-to-talk (PTT) messages sent or received.

### RELATED APPLICATIONS

This application is a continuation-in-part of U.S. application Ser. No. 13/093,998 filed on Apr. 26, 2011, which is a continuation-in-part of U.S. application Ser. No. 12/958,296 filed on Dec. 1, 2010, which is a continuation-in-part of U.S. application Ser. No. 12/616,958 filed on Nov. 12, 2009, which is a continuation-in-part of U.S. application Ser. No. 12/397,225 filed on Mar. 3, 2009, the entire disclosures and content of which are hereby incorporated by reference in their entirety.

### BACKGROUND OF THE INVENTION

1. Field of the Invention

The present invention is directed generally to wireless communication devices and, more particularly, to a system and method of determining social profiles for users of wireless communications devices communicating over short-range communication networks.

2. Description of the Related Art

Wireless communication networks have become commonplace. A vast array of base stations is provided by a number of different wireless service providers. Wireless communication devices, such as cell phones, personal communication system (PCS) devices, personal digital assistant (PDA) devices, and web-enabled wireless devices, generically referred to as “user equipment” (UE), communicate with the various base stations using one or more known communication protocols. While early cell phone devices were limited to analog operation and voice-only communication, modern wireless devices use digital signal protocols and have sufficient bandwidth to enable the transfer of voice signals, image data, and even video streaming. In addition, web-enabled devices provide network access, such as Internet access.

In all cases, the individual UEs communicate with one or more base stations. Even when two UEs are located a few feet from each other, there is no direct communication between the wireless devices. That is, the wireless devices communicate with each other via one or more base stations and other elements of the wireless communication network.

Some wireless service providers have included push-to-talk (PTT) technology that allows group members to communicate with each other using PTT technology. Thus, when one group member presses the PTT button, the communication from that individual is automatically transmitted to the communication devices of other group members. While this gives the appearance of direct communication between the wireless devices, the communications between group members are also relayed via one or more base stations as part of the wireless network.

Therefore, it can be appreciated that there is a need for UEs that can communicate directly with nearby wireless devices. The present invention provides this, and other advantages, as will be apparent from the following detailed description and accompanying figures.

### BRIEF DESCRIPTION OF THE SEVERAL VIEWS OF THE DRAWING(S)

FIG. 1 is a diagram illustrating a system architecture configured to implement a communication system in accordance with the present teachings.

FIG. 2 is functional block diagram of one of the UEs of FIG. 1.

FIG. 3 illustrates an embodiment of the system of FIG. 1 using an access point (AP) as part of a network.

FIG. 4 illustrates a dynamic network topology using an AP.

FIG. 5 is a flow chart illustrating the operation of an application program interface to implement the short-range wireless communication network.

FIG. 6A is one example of message storage within a UE of the system of FIG. 1.

FIG. 6B illustrates one example of an individual message and message header and provides details of an exemplary embodiment of the message header.

FIG. 6C illustrates a packet message and header and provides details of the packet header.

FIG. 7 illustrates the creation of a short-range communication network between two UEs.

FIG. 8 illustrates the addition of other UEs to the short-range communication network of FIG. 7.

FIG. 9 illustrates a dynamic change to the network configuration of the networks of FIGS. 7-8.

FIG. 10 illustrates the dissemination of information from one short-range communication network to another.

FIG. 11 illustrates the dissemination of information using an AP.

FIG. 12 illustrates the dissemination of information from a retail business.

FIG. 13 is a flowchart illustrating the operation of UE in the dynamic formation of short-range communication networks.

FIG. 14 illustrates the dynamic formation of short-range communication networks.

FIG. 15 illustrates further dynamic formation of short-range communication networks.

FIG. 16 illustrates a venue with a large number of distributed wireless access points.

FIG. 17 illustrates a sample data table of signal strength measurements to determine location of a user equipment.

FIG. 18 illustrates the use of the data in the table of FIG. 17 to determine the location of a user equipment within a venue.

FIG. 19 illustrates a system architecture in which a venue communicates with a Cloud network.

FIG. 20 illustrates the Cloud network of FIG. 19 communicating with multiple venues.

FIG. 21 is a flow chart illustrating the operation of the system of FIG. 19.

FIG. 22 illustrates a detailed block diagram of a social DNA determination module of the system of FIG. 19.

FIG. 23 is a screenshot illustrating a display provided by the system of FIG. 19.

FIG. 24 is a graphical representation of a user's social DNA score over time compared with average social DNA scores of other users of the system of FIG. 19.

### DETAILED DESCRIPTION OF THE INVENTION

The system described herein extends the normal operational features of conventional UEs. As described above, the conventional UE communicates with a wireless communication network base station using a first transceiver (i.e., a network transceiver). The extended capabilities described herein provide a second transceiver device that allows UEs to communicate directly with each other over a short distance and further describes network management techniques capable of managing a dynamic network that may change quickly.

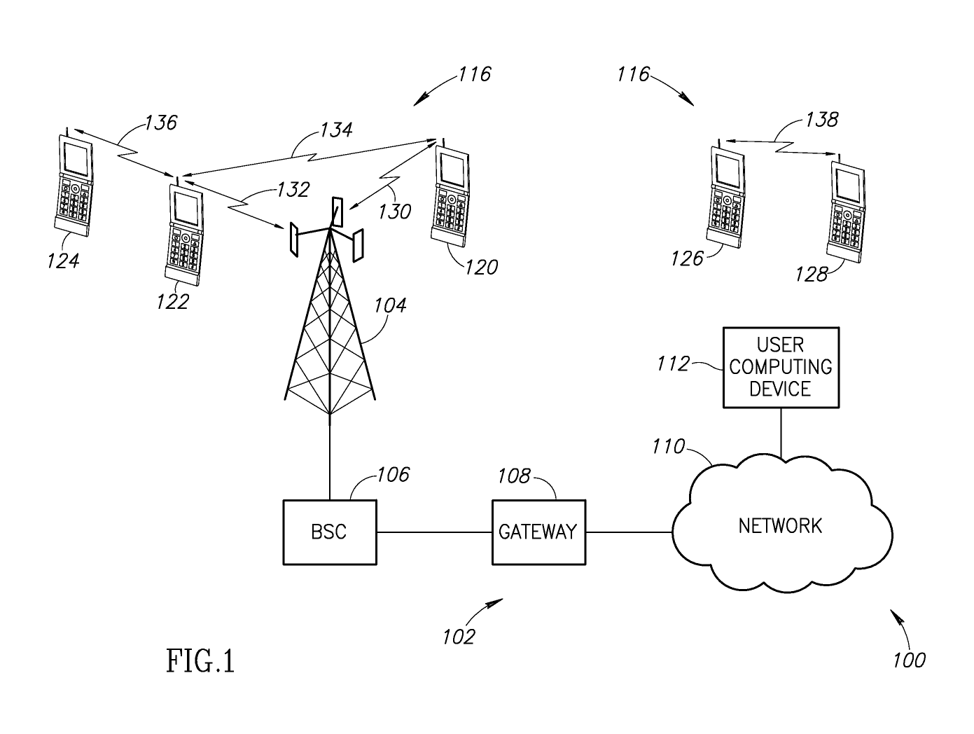

The UEs are illustrated as part of a system 100 illustrated in the system architecture in FIG. 1. Portions of the system 100 are conventional wireless network components that will be described briefly herein. The non-network communication capability, which may be referred to herein as a “jump-enabled” device or a “jump” device, will be described in greater detail below. The term “jump” refers to the ability of a wireless device designed and operated in accordance with the present teachings to jump from one short-range wireless network to another.

A conventional wireless communication network 102 includes a base station 104. Those skilled in the art will appreciate that the typical wireless communication network 102 will include a large number of base stations 104. However, for the sake of brevity and clarity in understanding the present invention, FIG. 1 illustrates only a single base station 104.

The base station 104 is coupled to a base station controller (BSC) 106. In turn, the BSC 106 is coupled to a gateway 108. The BSC 106 may also be coupled to a mobile switching center (not shown) or other conventional wireless communication network element. The gateway 108 provides access to a network 110. The network 110 may be a private core network of the wireless communication network 102 or may be a wide area public network, such as the Internet. In FIG. 1, a user computing device 112 is illustrated as coupled to the network 110.

For the sake of brevity, a number of conventional network components of the wireless communication network are omitted. The particular network components may vary depending on the implementation of the wireless communication network 102 (e.g., CDMA vs. GSM). However, these elements are known in the art and need not be described in greater detail herein.

Also illustrated in FIG. 1 are UEs 120-128. The UEs 120-128 are illustrative of many different types of conventional UEs capable of communicating with the base station 104 or other base stations (not shown) in the wireless communication network 102. Those skilled in the art will appreciate that the wireless communication network 102 may communicate using a variety of different signaling protocols. For example, the system 100 may be successfully implemented using, by way of example, CDMA, WCDMA, GSM, UMTS, 3 G, 4 G, LTE, and the like. The system 100 is not limited by any specific communication protocol for the wireless communication network 102.

As illustrated in FIG. 1, the UE 120 communicates with the base station 104 via a wireless network communication link 130. Similarly, the UE 122 communicates with the base station 104 via a wireless network communication link 132. Each of the UEs illustrated in FIG. 1 (e.g., the UEs 120-128) contain a conventional transmitter/receiver or transceiver components to permit conventional communication with the wireless communication network 102 via the base station 104 or other base station (not shown). Operational details of conventional network communication are known in the art and need not be described in greater detail herein.

In addition to the conventional network transceiver components, the jump-enabled UEs illustrated in FIG. 1 (e.g., the UEs 120-128) also include a second short-range transceiver to allow direct communication between the devices. This short-range communication is accomplished without reliance on the wireless communication network 102. Indeed, as will be described in greater detail below, the short-range transceivers in the mobile communication devices 120-128 permit the dynamic formation of a short-range communication network 116 that does not rely on the wireless communication network 102 provided by any wireless service provider. Thus, UEs can rely on the conventional wireless communication network 102 for some communications, but may also be part of the short-range communication network 116 formed between the mobile devices themselves. In the example of FIG. 1, the UE 120 communicates with the base station 104 via the wireless network communication link 130. Similarly, the UE 122 communicates with the base station 104 via the network wireless communication link 132. However, in addition, the UEs 120 and 122 may communicate directly with each other via a short-range communication link 134.

As illustrated in FIG. 1, the UE 124 is not in communication with the wireless communication network 102. However, the UE 124 can communicate directly with the UE 122 via a short-range wireless communication link 136. Also illustrated in FIG. 1 are the UEs 126-128. Although neither of these devices is in communication with the wireless communication network 102, the two devices are in direct communication with each other via a short-range wireless communication link 138. Thus, jump-enabled UEs must be in proximity with each other, but need not be in communication with the wireless communication network 102 or even in an area of wireless coverage provided by the wireless communication network.

The dynamic formation of one or more short-range networks 116 allows communication between the wireless communications devices 120-128 independent of the wireless communication network 102 even if the wireless communication network 102 is present and operational. The short-range communication network 116 advantageously allows communication in settings where the wireless communication network 102 is not present or in a situation where the wireless communication network is unavailable. For example, the wireless communication network 102 may be unavailable during a power outage or an emergency situation, such as a fire, civil emergency, or the like. In contrast, the short-range communication network 116 does not rely on any infrastructure, such as cell towers, base stations, and the like. As will be described in greater detail below, the short-range communication network 116 may be extended as jump-enabled UEs move throughout a geographic location.

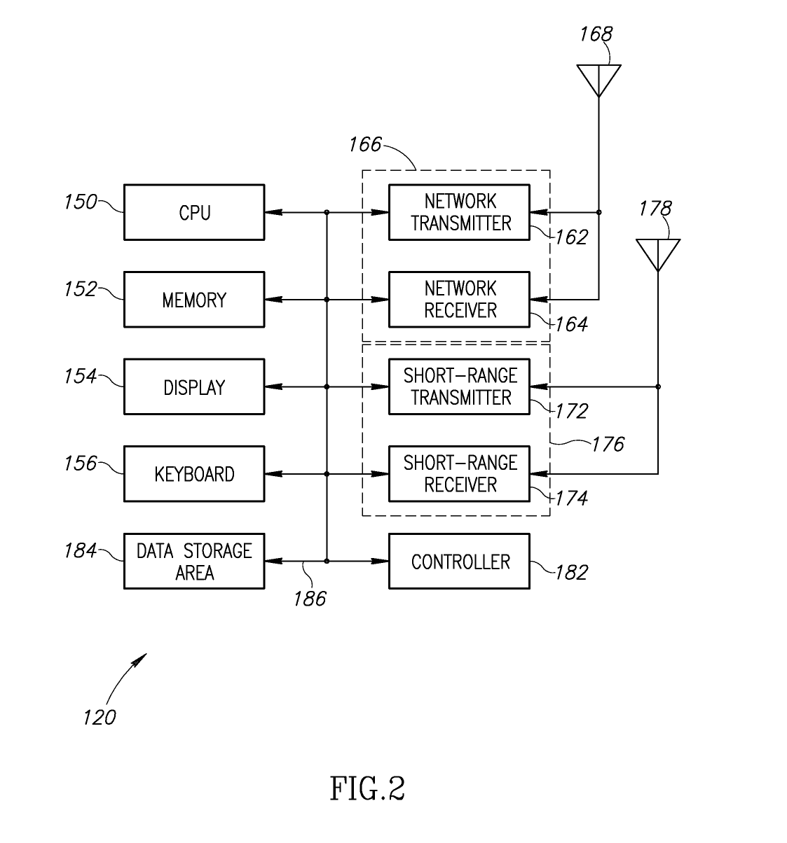

FIG. 2 is a functional block diagram illustrative of one of the UEs illustrated in FIG. 1 (e.g., the UE 120). The UE 120 includes a central processing unit (CPU) 150. Those skilled in the art will appreciate that the CPU 150 may be implemented as a conventional microprocessor, application specific integrated circuit (ASIC), digital signal processor (DSP), programmable gate array (PGA), or the like. The UE 120 is not limited by the specific form of the CPU 150.

The UE 120 in FIG. 2 also contains a memory 152. In general, the memory 152 stores instructions and data to control operation of the CPU 150. The memory 152 may include random access memory, ready-only memory, programmable memory, flash memory, and the like. The UE 120 is not limited by any specific form of hardware used to implement the memory 152. The memory 152 may also be integrally formed in whole or in part with the CPU 150.

The UE 120 of FIG. 2 also includes conventional components, such as a display 154 and a keypad or keyboard 156. These are conventional components that operate in a known manner and need not be described in greater detail. Other conventional components found in UEs, such as a USB interface, Bluetooth interface, camera/video device, infrared device, and the like, may also be included in the UE 120. For the sake of clarity, these conventional elements are not illustrated in the functional block diagram of FIG. 2.

The UE 120 of FIG. 2 also includes a network transmitter 162 such as may be used by the UE 120 for the conventional wireless communication network with the base station 104 (see FIG. 1). FIG. 2 also illustrates a network receiver 164 that operates in conjunction with the network transmitter 162 to communicate with the base station 104. In a typical embodiment, the network transmitter 162 and network receiver 164 share circuitry and are implemented as a network transceiver 166. The network transceiver 166 is connected to an antenna 168. The network transceiver 166 is illustrated as a generic transceiver. As previously noted, the mobile communication devices (e.g., the mobile communication devices 120-128) may be implemented in accordance with any known wireless communication protocol including, but not limited to, CDMA, WCDMA, GSM, UMTS, 3 G, 4 G, WiMAX, LTE, or the like. Operation of the network transceiver 166 and the antenna 168 for communication with the wireless communication network 102 is well-known in the art and need not be described in greater detail herein.

The UE 120 of FIG. 2 also includes a short-range transmitter 172 that is used by the UE 120 for direct communication with other jump-enabled UEs (e.g., the UE 122 of FIG. 1). FIG. 2 also illustrates a short-range receiver 174 that operates in conjunction with the short-range transmitter 172 to communicate directly with other jump-enabled UEs (e.g., the UE 122 of FIG. 1). In a typical embodiment, the short-range transmitter 172 and short-range receiver 174 are implemented as a short-range transceiver 176. The short-range transceiver 176 is connected to an antenna 178. In an exemplary embodiment, the antennas 168 and 178 may have common components are implemented as a single antenna.

FIG. 2 also illustrates a controller 182 and a data storage area 184. As will be described in detail below, the controller 182 controls the exchange of data between UEs that become part of the short-range communication network 116. The data storage 184 contains messaging data that will be exchanged between UEs in the short-range communication network 116. The data storage area 184 may be implemented as any convenient data structure. As will be described in greater detail below, the data storage area contains data (e.g., messages, personal profile information of contacts, a geographical location tag for each contact, and the like) that will be exchanged between UEs. The data may be stored as a simple list, part of a database, or any other convenient data storage structure. The data storage area 184 also stores a list of other nearby UEs that form part of the short-range wireless communication network 116.

The various components illustrated in FIG. 2 are coupled together by a bus system 186. The bus system may include an address bus, data bus, power bus, control bus, and the like. For the sake of convenience, the various busses in FIG. 2 are illustrated as the bus system 186.

In one embodiment, when the jump-enabled UE 120 comes within range of any other jump-enabled UE (e.g., the UE 122 of FIG. 1), it establishes a short-range wireless communication link (e.g., the short-range wireless communication link 134). In an alternative embodiment, the jump-enabled UE will establish a short-range communication network 116 with any nearby UE whether it is jump-enabled or not.

In an exemplary embodiment, the short-range transceiver 176 may be designed for operation in accordance with IEEE standard 802.11, sometimes referred to as WiFi. Many modern UEs are equipped with WiFi and may be readily upgraded to support the functionality described herein. Because the UEs 120-128 all include WiFi capability, short-range communication networks 116 may be formed even though the UEs may be designed to operate with incompatible wireless communication networks 102. For example, the UE 122 may be configured for operation with a GSM implementation of the wireless communication network 102. The UE 124 may be configured for operation with a CDMA implementation of a wireless communication network 102. Even though the UEs 122-124 are incompatible with respect to the respective wireless communication networks 102, the UEs 122-124 may still communicate directly with each other via the short-range communication network 116. Thus, the UEs 120-128 may operate compatibly to form the short-range communication networks 116 even though the network transceivers 166 (see FIG. 2) may operate with different incompatible wireless communication networks 102.

In one embodiment, a jump-enabled UE operates in an “ad hoc” mode defined by IEEE 802.11, which allows devices to operate in an independent basic service set (IBSS) network configuration. In this embodiment, one or more jump-enabled UEs (e.g., the UEs 120-128) communicate directly with each other in a peer-to-peer manner using unlicensed frequency bands. Manufacturer specifications for Wi-Fi devices may indicate that the UE Wi-Fi range is approximately 300 feet. Although the operational range of jump-enabled devices can be more or less than 300 feet, jump-enabled UEs are generally designed for short-range communication capability. In practice, the actual range may be considerably less, such as a 100 foot range. In addition, those skilled in the art will recognize that the actual transmission range may vary from one UE to another and may vary dramatically depending on obstructions. For example, natural obstructions (e.g., terrain or vegetation) or man-made obstructions (e.g., buildings or other structures) will have an impact on the range of the short-range transceiver 176. Furthermore, those skilled in the art will appreciate that the operational range of the short-range transceiver 176 will dynamically vary during operation. For example, the user may begin operation in one room of a building but move to a different room during operation of the short-range transceiver 176. Thus, the range and area of coverage of a UE can be highly variable.

In accordance with IEEE 802.11, two WiFi devices must be associated with each other to exchange data. This technique is well known in the use of personal computers where a WiFi connection may be established between a PC and a wireless router or wireless AP at home, at the office, or some public location (e.g., an airport, coffee shop, and the like) that provides a wireless “hot spot.” In this conventional operation, the user of the PC must enable a process to seek out any nearby WiFi wireless router or wireless AP. When one or more wireless routers are detected, the user manually selects a wireless router with which to communicate. In a setting such as an airport, the wireless AP is typically unencrypted and broadcasts an identification in the form of a service set identifier (SSID). For example, the SSID in the Los Angeles International Airport may, for example, be broadcast as “LAX Wireless Service.”

In a home wireless network, the wireless router will also have an SSID (e.g., The Smith Family). In addition, a home wireless router may include known forms of encryption such as WEP, WPA-2, or the like. If encryption is selected, the wireless router will have an encryption key. For successful communication with an encrypted router, the PC user must select that router when viewing the list of available WiFi connections and provide the appropriate encryption key to match the encryption key for the selected wireless router.

As will be discussed in greater detail below, the system 100 goes beyond some of the conventional operation of WiFi standards to permit a large number of UEs to communicate directly with each other. In one embodiment, a local hot spot is used to initiate the formation of the short-range communication network 116. Once established, the short-range communication network 116 may continue to exist even if the hot spot (or group owner) is no longer present. In yet another alternative embodiment, described below, the UEs may be pre-programmed to utilize a common SSID, iprange, and port to spontaneously form a short-range communication network 116 even in the absence of any hot spot.

In an exemplary embodiment of the system 100, each UE (e.g., the UEs 120-128) transmits a beacon signal with the same SSID, such as the SSID “JUMMMP” to identify the device as a jump-enabled UE. In addition, the beacon frame includes several other data fields such as a media access layer (MAC) address for source and destination. In the beacon frame, the destination MAC address is set to all ones to force other UEs to receive and process the beacon frame. The beacon frame used in the system 100 may also include conventional elements, such as a time stamp used for synchronization with other wireless devices, information on supported data rates, parameter sets that indicate, for example, transceiver operational parameters such as the IEEE 802.11 channel number and signaling method such as operation at the physical layer (PHY) and operation in a direct frequency spectrum (DSSS) or a frequency hopping spread spectrum (FHSS) operational modes. These conventional WiFi parameters are known in the art and need not be described in greater detail herein.

In addition, since there is no AP, all jump-enabled UEs take on the responsibilities of the MAC layer that controls, manages, and maintains the communication between the jump-enabled UEs by coordinating access to the shared radio channel and the protocols that operate over the wireless medium. In an exemplary embodiment, the MAC is implemented in accordance with IEEE 802.2. At the PHY layer, the transceiver may operate in a DSSS or a FHSS operational mode. Alternatively, the PHY layer may be implemented using infrared transceivers. The IEEE 802.11 standard defines a common operation whether devices are using the ad hoc or the infrastructure mode. The use of the ad hoc mode only affects protocols, so there is no impact on the PHY layer. Thus, the UE 120 may operate under IEEE 802.11a at 5 gigahertz (GHz) under IEEE 802.11b/g at 2.4 GHz, or IEEE 802.11 n, which operates at both 2.4 GHz and 5 GHz. Those skilled in the art will appreciate that the UE of the system 100 may be readily adapted for operation with future versions of IEEE 802.11.

In an alternative embodiment, the UEs 120-128 may be configured in accordance with IEEE WiFi Direct standards. WiFi Direct allows any UE in the short-range communication network 116 to function as the group owner. WiFi Direct simplifies the process of establishing a communication link. For example, the WiFi protected set up allows a communication link to be established by entering a PIN or other identification or, simply pressing a button. As will be described herein, the jump-enabled UEs actively seek to establish links with other jump-enabled devices to automatically establish a short-range communication network 116.

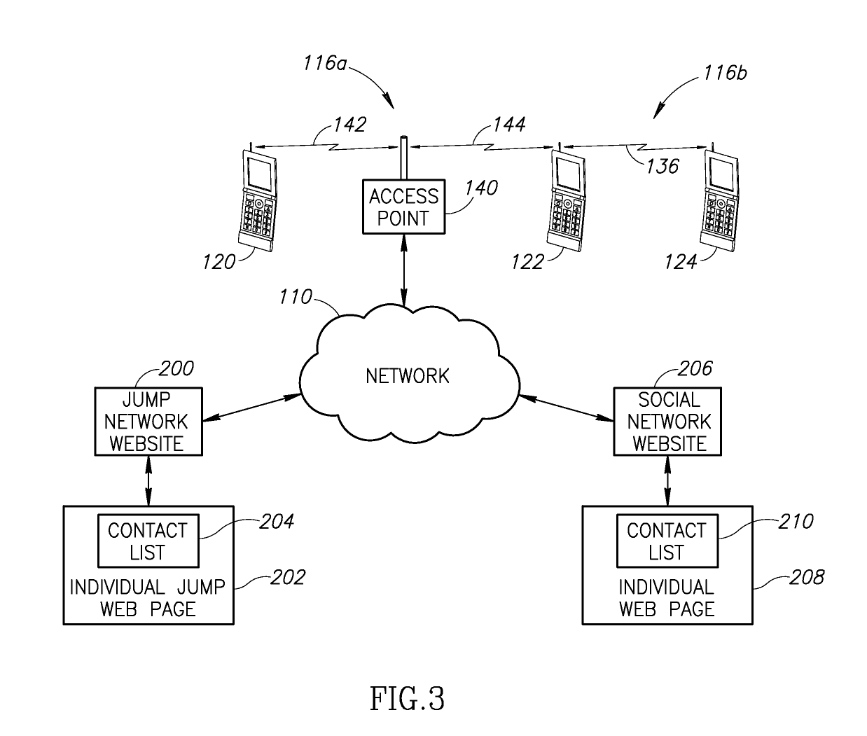

In yet another alternative embodiment, illustrated in FIG. 3, the jump-enabled UEs (e.g., the UEs 120-122) may communicate with an access point (AP) 140, such as a WiFi base station, wireless AP, wireless router, or the like. As will be described in greater detail below, a UE (e.g., on of the UEs 120-124) may function as the AP 140 to permit others of the UEs in the short range communication network 116 to access the network 110 via the UE serving as the AP. FIG. 3 illustrates a wireless communication link 142 established between the AP 140 and the UE 120. Similarly, the UE 122 establishes a wireless communication link 144 with the AP 140. Thus, a short-range communication network 116a is formed in conjunction with the AP 140. To assist in a better understanding of the present disclosure, short-range communication networks will be generally referred to by the reference 116. Specific examples of short-range communication networks will be referred to by the reference 116 and an alphabetic identifier (e.g., the short-range communication network 116a in FIG. 3).

Depending on the physical proximity of the UEs 120-124, there may be one or more short-range communication networks 116 formed. In the example of FIG. 3, the UEs 120-122 are both within range of the AP 140. Therefore, the first short-range communication network 116a can be formed with the UEs 120-122 and the AP 140.

The UE 124 is within range of the UE 122, but is not within range of the AP 140. In one embodiment, the UE 124 may be become part of the short-range communication network 116a via the UE 122. In this embodiment, the UE 122 functions as a “repeater” or relay to relay information between the UE 124 and other parts of the short-range communication network 116a. In another embodiment, a second short-range communication network 116b is formed with the UEs 122-124. In this exemplary embodiment, the UE 122 is part of both short-range communication networks 116a-116b. The UE 122 may simultaneously be a member of both short-range communication networks 116a-116b or may be logically connected to both short-range communication networks 116a-116b by alternately switching between the short-range communication networks 116a-116b.

The AP 140 is coupled to the network 110 in a conventional manner. This can include a wired or wireless connection directly to the network 110 or via an intermediate network gateway, such as those provided by an Internet Service Provider (ISP). FIG. 3 also illustrates a JUMMMP Network website 200, which may support an individual web page 202 for each member (e.g., an individual person, business, organization, etc.) of the JUMMMP Network. FIG. 3 also illustrates a generic conventional social network website 206, which may support an individual web page 208 for each member of the social network. The JUMMMP network website 200 and social network website 206 are each coupled to the network 110. Although illustrated in FIG. 3 as two separate network websites, those skilled in the art will appreciate that the JUMMMP website 200 effectively functions as a social network website. Similarly, the JUMMMP website technology can be incorporated into existing social network websites. Thus, the two separate websites illustrated in FIG. 3 can effectively be combined into a single website.

As discussed in detail in co-pending U.S. application Ser. No. 12/616,958, filed on Nov. 12, 2009 and assigned to the assignee of the present application, the user of a jump-enabled UE (e.g., the wireless device 120) may use the web-browsing capability of the UE to access the individual jump web page 202 for the individual with whom contact has just been made to learn more about that individual. Alternatively, the user of a jump-enabled UE (e.g., the wireless device 120) may use the web-browsing capability of the UE to access the user's own individual jump web page 202 to store information for the individual with whom contact has just been made. A contact list 204, which is typically a portion of the individual jump web page 202 is configured to store contact information. Similarly, the individual jump web page 208 of the social network 206 can include a contact list 210 to store contact information. In one embodiment, the contact information may include a user profile exchanged along with individual messages between users. As will be discussed in greater detail below, the user profile can include user name and preferences, as well as information about the specific exchange of messages. For example, the user profile can include the date and time at which messages were exchanged, geo-location data (e.g., latitude and longitude) of the sender of a message, and the like, and can also be stored as user profile data in the contact list 204. Applications for the profile data are described in greater detail below.

The UEs 120-128 (see FIG. 1) generally have sufficient memory capacity to temporarily store contact information. In an exemplary embodiment, the UE (e.g., the UE 120) can temporarily store new contact information until access to the network 110 becomes available at a later time. In addition, the UE 120 can store designated contact information (e.g., “Favorites”) on a more permanent basis. Long-term storage of contact information requires access to the network 110. In the embodiment of FIG. 1, access to the network 110 may be provided via the base station 104 in a conventional manner. The UE 122 may access the network 110 by communicating directly with the base station 104. In the embodiment of FIG. 3, access to the network 110 may be provided via the AP 140, as described above. For example, the UE 122 in FIG. 1 may access the network 110 by communicating directly with the AP 140 via the short-range communication link 144. Alternatively, the UE 122 can access the network 110 and the JUMMMP network website 200 via the wireless communication link 132 to the base station 104. Network access via the gateway 108 is well known in the art and need not be described in greater detail herein.

In an alternative embodiment, access to the network 110 may be provided via another jump-enabled UE. For example, in FIG. 1, the UE 122 can communicate with the base station 104 via the wireless communication link 132 while the UE 124 cannot communicate directly with the base station. However, the UE 124 is in proximity with the UE 122 and can communicate with the UE 122 via the wireless communication link 136 as part of the short-range communication network 116. In this embodiment, the UE 124 can use the UE 122 as a repeater or relay to allow the UE 122 to access the network 110 via the UE 122 and the base station 104.

Similarly, in the embodiment of FIG. 3, the UEs 120-122 can communicate directly with the AP 140 via the wireless communication links 142-144, respectively. The UEs 120-122 can also communicate with each other via the AP 140 thus forming the short-range communication network 116a. As seen in FIG. 3, the UE 124 cannot communicate directly with the AP 140. However, the UE 124 is in proximity with the UE 122 and can communicate with the network 110 via the UE 122 and the AP 140.

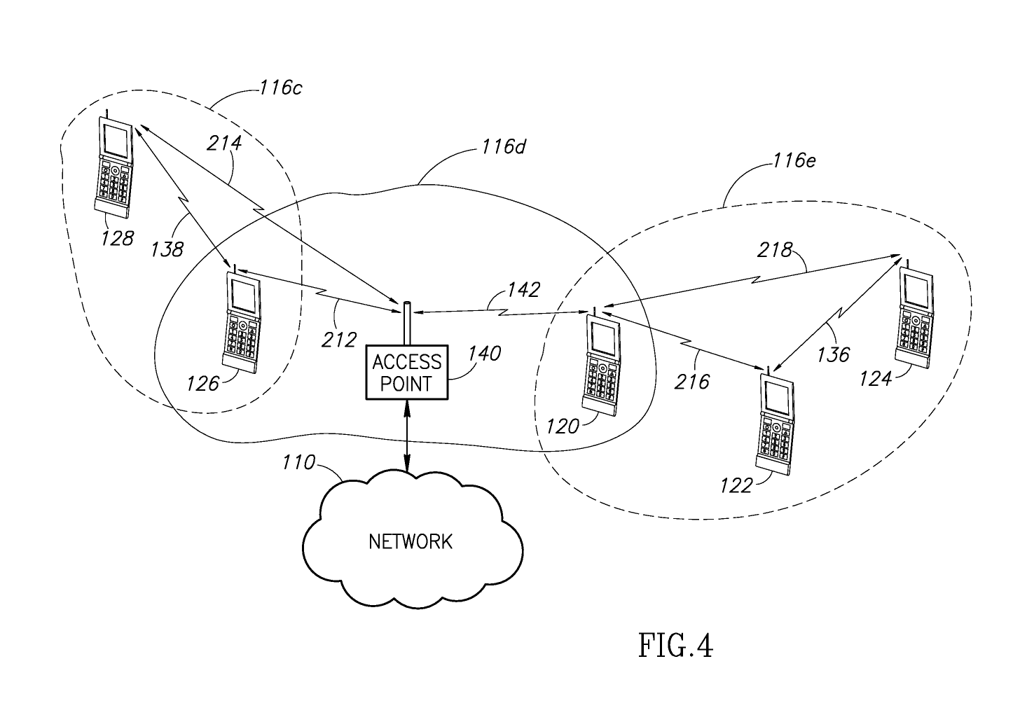

As previously noted, the system 100 provides for the dynamic formation and rapid change in the topography of the short-range communication networks 116. For example, FIG. 1 illustrates a first short-range communication network 116 formed with the UEs 120-124 and a second short-range communication network 116 formed between the UEs 126-128. FIG. 4 illustrates the dynamic nature of the wireless communication networks 116. For example, if the UE 128 is initially within range of the UE 126, but out of range of the AP 140, the UEs 126-128 may form a short-range communication network 116c using the short-range communication link 138. If the UE 126 comes within range of the AP 140, a wireless communication link 212 is formed. In that event, the UE 126 may become part of a short-range communication network 116d formed between the AP 140 and the UEs 120 and 126. At this particular moment in time, the mobile communication device 126 may be part of both the short-range communication network 116c and the short-range communication network 116d. As discussed above, the UE 126 may actually be part of both the short-range communication networks 116c-116d or may logically be connected to both the short-range wireless communication networks by switching back and forth between the short-range communication networks 116c-116d. The logical switching between the short-range communication networks 116c-116d is transparent to the user. Other examples of the short-range communication network 116 are described below in which no AP 140 is present.

Alternatively, the UE 128 may become part of the short-range communication network 116d using the UE 126 as a relay to the AP 140. If, at a later time, the UE 128 comes within range of the AP 140, a wireless communication link 214 is formed therebetween. At that point in time, the short-range communication network 116c effectively ceases to exist since the UEs 126-128 are now part of the short-range communication network 116d.

The UE 120 may be part of the short-range communication network 116d by virtue of the short-range communication link 142 coupling the UE 120 to the AP 140. If the UE 120 comes within range of the UEs 122-124, wireless communication links 216-218 will be formed to couple the UEs 120-124 and thereby dynamically form a short-range communication network 116e. At this point in time, the UE 120 may simultaneously be part of the short-range communication network 116d and the short-range communication network 116e. Alternatively, the UEs 122-124 may become part of the short-range communication network 116d via the UE 120.

If the UE 120 subsequently moves out of range of the AP 140, the wireless communication link 142 is broken. Therefore, there will no longer be an overlap between the short-range communication networks 116d-116e. The UE 120 would remain part of the short-range communication network 116e so long as it remains within range of the UE 122, the UE 124, or both. Thus, those skilled in the art will appreciate that short-range communication networks are dynamically formed, modified, and dissolved as the UEs move in and out of range with each other and central points, such as the AP 140. Furthermore, if the UE 120 comes back into range of the AP 140, the wireless communication link 142 can be reestablished. When this happens, all prior communications from the short-range communication network 116e will be transferred to the short-range communication networks 116d and 116c (and visa-versa) through the re-echoing function described above. That is, the various UEs will resynchronize the data in the date storage area 184 (see FIG. 2). Those skilled in the art will also appreciate that the short-range communication networks 116 may be formed, modified, and dissolved without the presence of the AP 140.

FIG. 4 illustrates the UE 120 as a key component in the short-range communication network 116e because it connects the UEs 122-124 to the AP 140. If the UE 120 suddenly moved out of range of the AP and/or the UEs 122-124 that connection may be broken. Similarly, if the user of the UE 120 suddenly turned off the device, the link between the short-range communication network 116e and the AP 140 would disappear. The UEs 122-124 still communicate with each other via the wireless communication link 136 and will still search for other UEs with which to connect. In addition, either of the UEs 122-124 will attempt to find the AP 140 or a hot spot from which either of the UEs may access the network 110.

FIG. 4 illustrates a sparse network with only five UEs. However, those skilled in the art can appreciate that there may be a very large number of UEs in proximity with each other. For example, if FIG. 4 is illustrative of a large shopping mall, there may be hundreds of UEs within the mall. Thus, the short-range communication networks 116 may be large and extensive. There may be a large number of UEs that are simultaneously present in two or more short-range communication networks 116. In addition, many UEs would provide overlapping coverage with multiple short-range communication networks 116. In this scenario, the entire mall and surrounding parking area could be effectively covered by a mesh network comprising dozens or hundreds of short-range communication networks 116. Thus, in the situation illustrated in FIG. 4 where the UE 120 is turned off or moved out of range of other UEs is less likely to cause the total isolation of the short-range communication network 116e. If the UE 120 were suddenly removed, either by powering down or by the departure from the area, many other UEs (not shown) in the same proximity would be able to replace the connectivity between the short-range communication network 116e and the AP 140.

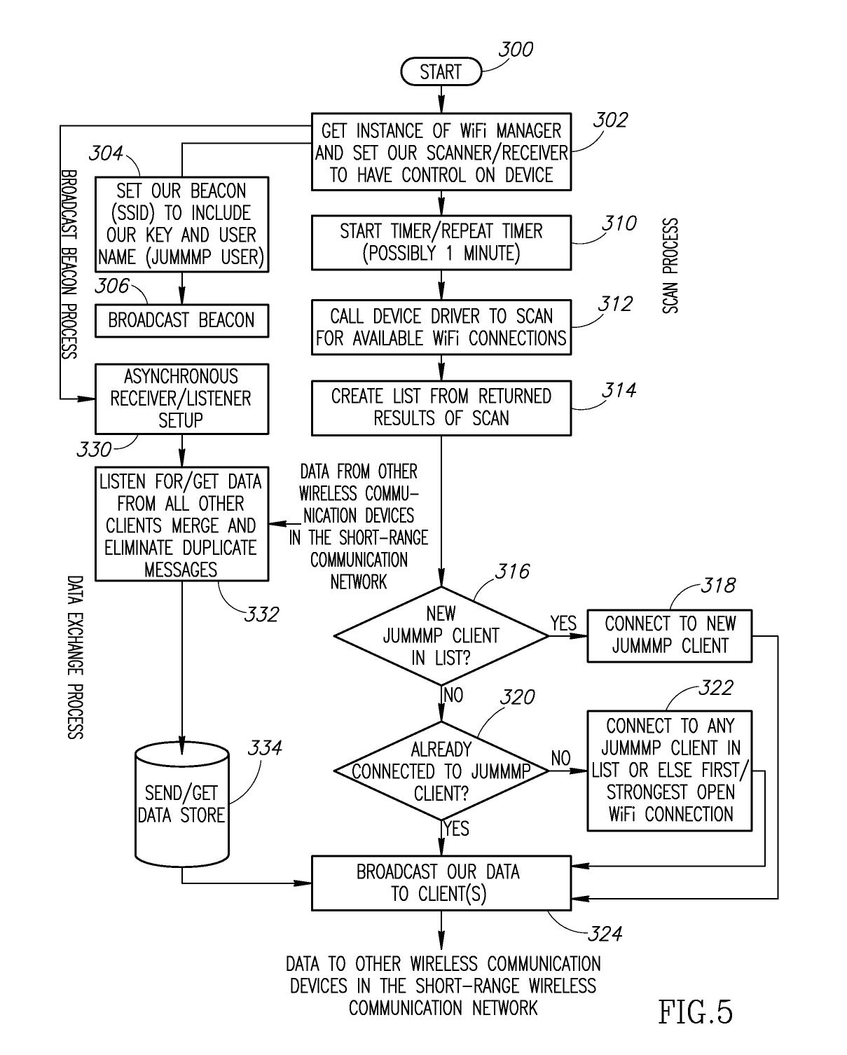

FIG. 5 illustrates a flow chart and functionality of an application program interface (API) utilized by jump-enabled UEs. The JUMMMP API may be programmed into the UE at the time of manufacture or downloaded in a conventional manner. The JUMMMP API allows a UE with a short-range transceiver 176 (see FIG. 2) to function as a jump-enabled device. Those skilled in the art will understand the programming steps to download and install the JUMMMP API. The controller 182 (see FIG. 2) in the UE (i.e., the UE 120) executed the JUMMMP API. As previously noted, the controller 182 may be implemented as a set of instructions stored in the memory 152 and executed by the CPU 150.

At a start 300, shown in FIG. 5, the JUMMMP API is already present within the various UEs. FIG. 5 illustrates a number of processes that are performed by the JUMMMP API, including a Broadcast Beacon Process, a Scan Process, and a Data Exchange Process. The separate processes may be executed repeatedly by the UE.

At step 302, the UE enables an instance of a WiFi Manager that controls the WiFi communication hardware (i.e., the short-range transceiver 176 of FIG. 2) and sets the JUMMMP API to have control of the short-range transceiver. The three processes listed above all require the operation of step 302 such that the JUMMMP API gains control of the short-range transceiver 176. Any UE that includes a WiFi transceiver will include some control functionality, labeled herein as the WiFi Manager to control the WiFi communication transceivers using one or more software drivers that control the actual hardware. With the installation of the JUMMMP API, the UE 120 may hook into the existing WiFi Manager and utilize some of the WiFi Manager functionality. Certain functions, such as the Scan Process, may be controlled to a greater degree by the JUMMMP API.

The Broadcast Beacon Process is initiated to inform wireless devices of the presence of a jump-enabled UE. In step 304, the beacon signal of the jump-enabled UE is altered such that the SSID will contain a key word identifying the UE as part of a jump network (e.g., SSID=JUMMMPNet). Those skilled in the art will appreciate that IEEE802.11 provides for user-specified data to be broadcast as part of the beacon signal. In a current implementation of IEEE802.11, a total of 32 characters are available for user-defined purposes. In step 304, the beacon signal is also altered to include a local user name and may, optionally, include a unique alphanumeric identifier and additional flags that may be used for applications utilizing the JUMMMP API. Application programs can use the JUMMMP API to insert application-specific data into the beacon signal. For example, a social networking application program can use the JUMMMP API to insert information such as age, sex, and interests of the user that will be broadcast in the beacon signal and used by other UEs running the social networking application program. In another example, a sports application program can insert sports scores or updates into the beacon signal. If there are too many scores to fit into the allocated space in a single beacon signal, the scores can be changed with each beacon signal.

In step 306, the UE 120 periodically transmits the beacon signal. The beacon signal may be set to broadcast continuously or at a predetermined interval, such as, by way of example, every ten seconds. Those skilled in the art will appreciate that the interval used to broadcast the beacon signal may be altered based on system metrics. The beacon broadcast process ends at step 306 with the short-range transceiver 176 continuing to broadcast the beacon signal.

While the jump-enabled UE 120 is broadcasting its own beacon signal, it also listens for the beacon signals broadcast from other jump-enabled UEs (e.g., the UE 122). The Scan Process illustrated in FIG. 5 outlines the actions of the JUMMMP API to detect and communicate with other jump-enabled devices. In the Scan Process, illustrated in FIG. 5, a timer is started in step 310. As discussed above, step 302 has already been performed to permit the JUMMMP API to gain control of the WiFi Manager. The timer process in step 310 determines how frequently a jump-enabled UE 120 will scan for other jump-enabled UEs.

In step 312, the JUMMMP API controls the WiFi Manager to activate a device driver in the UE to scan for available WiFi connections. In step 314, the jump-enabled UE creates a list of results returned from the scan in step 312. The list of results may be stored in the data storage area 184 (see FIG. 2). It should be noted that this list may include non-jump-enabled UEs as well as jump-enabled UEs.

In decision 316, the controller 182 (see FIG. 2) in the jump-enabled UE 120 determines whether any new jump-enabled UEs are present on the list. Those skilled in the art will appreciate that the UE performing the scan process may be designated as the group owner while any detected UEs (whether or not they are jump-enabled devices) may be designated as client devices. As previously discussed, in many WiFi modes of operation, one wireless device must be designated as the group owner while others of the UEs are designated as client devices. Those skilled in the art will appreciate that the Scan Process (see FIG. 5) is not limited only to the group owner. In an exemplary embodiment, all jump-enabled UEs perform a Scan Process in an effort to discover and connect with other UEs. Furthermore, while there may be a preference to connect with other jump-enable UEs, the Scan Process will discover any nearby UE, whether or not it is jump-enabled, and may connect to any nearby UE, whether or not it is jump-enabled.

If there are new jump-enabled UEs in the list, the result of decision 316 is YES and, in step 318, the UE 120 connects to the new jump client device.

If there are no new jump devices detected as a result of the scan in step 312, the result of decision 316 is NO and, in decision 320, the UE 120 determines whether it is already connected to another jump-enabled client device. If the UE is not already connected to a jump-enabled client device, the result of decision is NO and, in step 322, the jump-enabled UE will attempt to connect to any jump client device in the list (created in step 314) or else attempt to establish a connection with the first open WiFi connection from the list created in step 314. Alternatively, the jump-enabled UE may attempt to connect to the open WiFi connection having the strongest signal in step 322.

If the UE is already connected to a jump client, the result of decision 320 is YES. If the UE has connected to a new jump client in step 318, or connected to a WiFi device in step 322, or is already connected to a jump client device from decision 320, the UE 120 broadcasts stored data to any client device(s) to which it is able to connect in step 324. As will be described in greater detail below, the system 100 is capable of distributing messages throughout a short-range communication network 116 and may even distribute messages from one short-range communication network to another.

FIG. 5 also illustrates a message exchange process to facilitate the exchange of data between UEs in a particular short-range communication network 116 (e.g., the short-range UE 116e of FIG. 4). The data exchange process in the JUMMMP API is also illustrated in FIG. 5. As with other processes illustrated in FIG. 5, the JUMMMP API begins with step 302 in which the WiFi manager is instantiated and the controller 182 (see FIG. 2) has control of the short-range transceiver 176. In step 330, the controller 182 configures the short-range receiver 174 to detect transmitted beacon signals from other jump-enabled UEs. The UE 120 has stored messages previously received from other clients and stored the received messages in the data storage area 184 (see FIG. 2). In step 332, the UE listens for and gets data from all other jump-enabled clients. In step 332, the controller 182 also merges the messages received from other clients in step 332 and stored in the data storage area 184 as well as newly received messages in order to merge the messages and eliminate duplicate messages. In this manner, the UE manages the message data within the data storage area 184. Further details of message management will be provided below.

In step 334 the controller 182 stores the merged message data in the data storage area 184 and in step 324, the merged message data is broadcast to other clients' jump-enabled UEs that form part of the short-range communication network 116. Thus, when two jump-enabled UEs detect each other and form a short-range communication network 116, the UEs exchange message data with each other such that the message data is synchronized between the two devices. If a third UE joins the short-range communication network 116, its message data is exchanged between the two UEs that have already formed the network. Thus, the UEs within a particular short-range communication network 116 are effectively synchronized with the respective message data.

As will be described in greater detail below, the message data exchanged between UEs in the short-range communication network 116 may include a main header as well as a list of individual messages that may be intended for users of the UEs within the particular short-range communication network as well as messages for other jump-enabled UEs that are not part of the particular short-range communication network. Messages to be exchanged between UEs in a short-range communication network 116 may be categorized based on the nature of the message. In an exemplary embodiment, messages may be categorized as Public Messages, Group Messages, Direct Messages, and Status Messages. Public Messages may be transmitted to anyone within range of the UE (e.g., the UE 120). This may include emergency messages, messages broadcast from a retailer, and the like. Group Messages are intended for a specific group or organization, such as a scout troop or employees of a particular company or part of any formed group. Direct Messages are intended for a specific individual. In addition, the UE 120 may transmit Status Messages, which can include, by way of example, a list of other wireless devices currently in the particular short-range communication network 116, a list of recent UEs in the particular short-range communication network, a list of other short-range communication networks in which the UE 120 was recently a member, or the like. The data exchange process illustrated in FIG. 5 can include one or more of these message categories. Other message categories may be created as necessary.

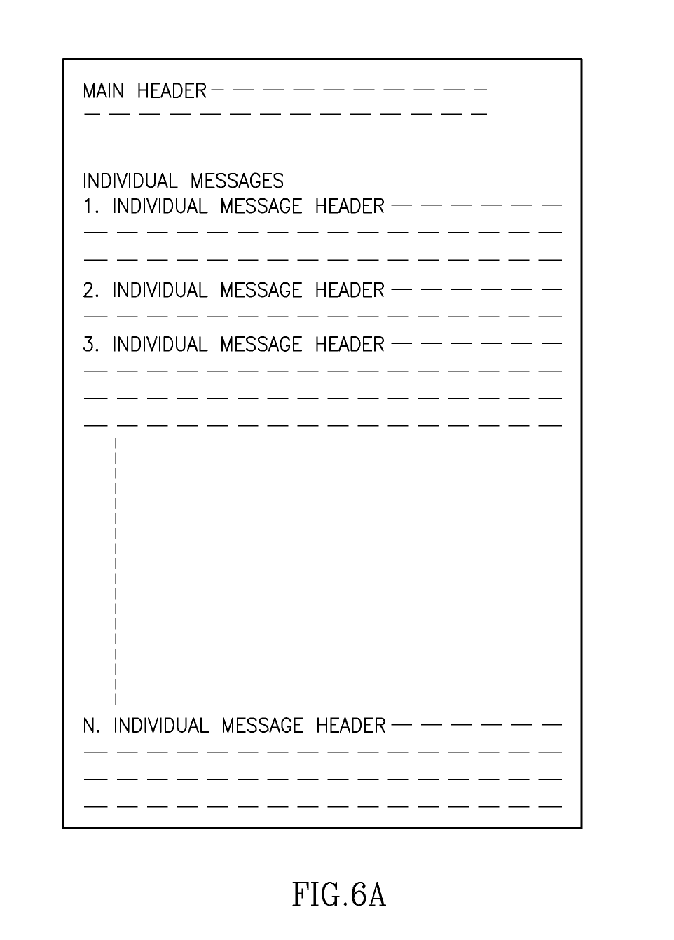

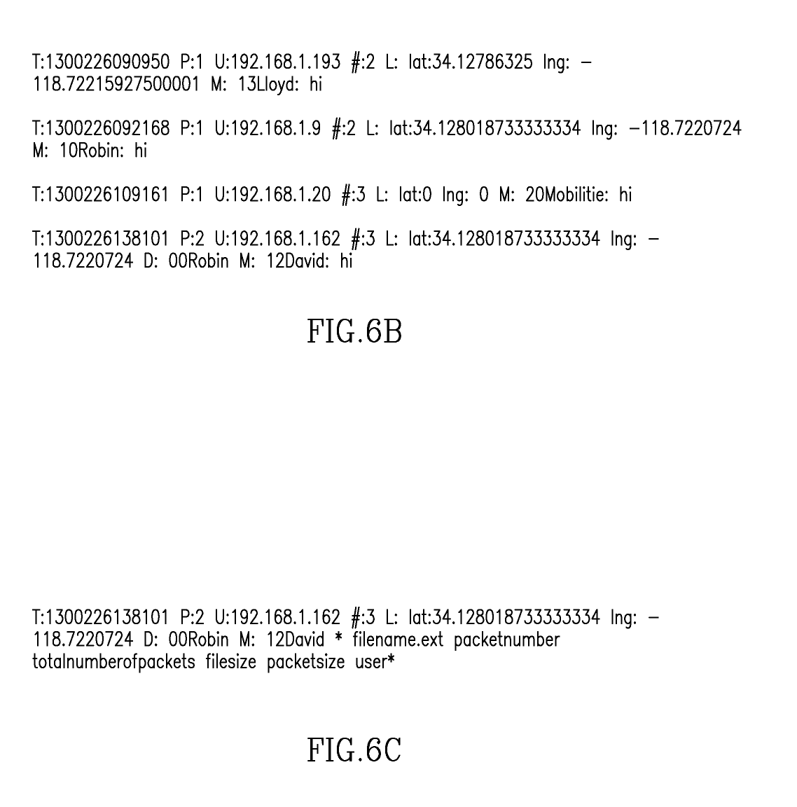

In one embodiment, all public messages and group messages may be contained in one file and all direct messages contained in a separate file. The messages may be formatted as standard text files or xml files that have a main header and individual message headers, as illustrated in FIG. 6A.

The main header for all messages may contain at least the following:
1. Date/time of last modification;
2. Message count;
3. Last synch date/time and user name of the UE with which the last synchronization was performed; and
4. Our local user name.

This main header can help maintain synchronization between the UEs without excess exchange of data or unnecessary processing by any of the UEs. For example, the last synch date/time may indicate that a recent synchronization has occurred and that another synchronization is unnecessary at the present time.

Alternatively, synchronization data may be provided in the form of a data flag in a status byte of the beacon signal. As previously noted, the beacon signal permits the transmission of a limited amount of user-defined data. A status data byte may contain one or more data flags. One data flag may be a New_Data flag to indicate that a particular UE (e.g., the UE 120) has new data. The UE 120 may synchronize its message data with other UEs within the particular short-range communication network 116. Following the synchronization, the New_Data flag may be reset.

Those skilled in the art will appreciate that other conventional data synchronization techniques may be used. For example, the UEs within a particular short-range communication device 116 may simply synchronize with each other on a periodic basis. For example, the UEs within a particular short-range communication network 116 may synchronize every ten minutes or some other selected time period. The re-synchronization period may be dynamically altered based on factors such as the number of UEs within a particular short-range communication network 116. Furthermore, the addition of a new UE into the particular short-range network 116 may force a re-synchronization process even if the time period has not yet expired for the other ones of the UEs.

In addition to the text message itself, individual message headers will contain at least the following:
1. Date/time stamp of message creation;
2. User name that created the message (i.e., originator);
3. Destination user name/group name/global for direct messages/group messages/public messages; and
4. Urgency level.

FIG. 6B illustrates several example messages and message headers. The “T” information is a time stamp using standard computer time format. The “P” information indicates the message designation as a public (P:1) or private (P:2) message or may include profile information (P:0) regarding the sender's personal information, education, hobbies and interests, and the like. Other profile information has been previously discussed. The “U” information is the IP address of the message sender. To provide more reliable sender information, a unique code such as the IMEI of the sender telephone could be included. The “L” information is the longitude and latitude of the message sender. The “M” information is the username of the sender of the message. The “D” information is the identification of the recipient of a private message (i.e., P:2). The username must be unique for each user. A username could, for example, include the user's mobile phone number.

The geo-location data (e.g. longitude and latitude) can be obtained in several possible ways. In one embodiment, the UE (e.g., the first UE 120 in FIG. 1) may have built-in GPS. Other possible location determination technologies include WiFi, 3 G, approximate triangulation, or last known location of the user. Other known location technologies may also be implemented in the system 100.

In one embodiment, previously discussed, contact information may be stored in the data storage area 184 (see FIG. 2) of the UE and periodically uploaded to the contact list 204 (see FIG. 3) for the individual JUMMMP webpage when access to the network 110 is available. In an alternative embodiment, the data storage area 184 may store a list of all text messages received, such as those illustrated in the example of FIG. 6B. The text message data in FIG. 6B can be stored in any convenient format, such as a table, database, or the like. Other data structures known in the art may also be satisfactorily employed to store the text message data. Those skilled in the art will appreciate that the storage capacity of the UE is sometimes limited. Accordingly, when access to the network 110 becomes available, the UE may upload the text message to the individual JUMMMP webpage 202 or to another computer designated by the user. This data storage structure contains all of the information of text messages sent or received by the UE during some prior period of time. This includes information regarding personal profiles that may have been received during encounters with other individuals. The personal profile information can include an email address, or other contact information that was received as part of text messages. In addition, there are geo-location data tags for each text message. Using known technology, the geo-location data can be used to pinpoint the location of an individual on a map. This collection of data may be mined and used in a number of personal or business applications. For example, the geo-location information can be used to determine a person's personal shopping preferences. The data can be collected by a business and located on a computer for each store location. Under circumstances where network connectivity is unavailable, such as during an emergency or power outage situation, or when the UE is out of range of any network AP, the data storage area 184 within the UE itself maintains the integrity of the data messaging received and thus provides data storage capability not located in the Internet. This “outernet” connectivity can be independently maintained by each UE.

In addition to the text messaging described above, the UEs (e.g., the first UE 120 in FIG. 1) can provide other forms of data. For example, a data file may be packetized and sent in a manner similar to that used for text messaging described above. FIG. 6C illustrates an example data header for non-text message data. For example, the data file could be audio data or any binary data file, such as images (e.g., an image captured by an in-phone camera), documents, video, and the like. Images could be in the form of a JPEG, PDF, or known image file formats. Documents could be in the form of word processor documents, such as Microsoft Word. Video data files can be in any known format, such as MPEG.

As with text messages, data files can be private or public. That is, a data file can be private and intended for only a specified recipient or a designated group of recipients. Alternatively, the data file may be broadcast publicly to any nearby recipient. Application programs in the UE of the intended recipient can process the data files. For example, audio and/or video CODECS in the UE can process audio and video data files. Below the application layer, security measures can prevent unauthorized recipients of data files (or text messages) from accessing those messages. In addition, text messages or data files may be encrypted prior to transmission to prevent unauthorized interception of the message data.

As described above with respect to FIG. 6A, text message data is exchanged between nearby UEs. Each UE examines message data in the data storage area 184 (see FIG. 2) to eliminate duplicate messages. Whenever the UEs exchange messages, they exchange all messages in the data storage area 184.

Those skilled in the art will appreciate that non-text messages, such as audio data, video data or image data, are generally much larger in size than a text message. In one embodiment, the system 100 can treat non-text data messages in the same manner as text messages. That is, each wireless device may send all data in the data storage area 184 (see FIG. 2) every time it exchanges messages with other nearby UEs.

In an alternative embodiment, non-text message data may be treated differently. In this embodiment, as a data packet is sent from one UE to all nearby wireless communications devices, each of the receiving UEs will transmit the received data packet only once. If the data packet has been received before it will be ignored by the receiving UE.

In yet another embodiment, each UE that receives the data packets for a particular data message will store those data packets to reassemble the original message. In this aspect, each nearby UE will receive most or all of the data packets for a particular data message. If the intended recipient of a data message does not receive all of the data packets for the particular message, it can broadcast a request for those missing packets. In this manner, the nearby UEs may act as “servers” to store and relay data packets in response to the request for missing data packets. If the intended recipient is missing a larger number of packets, it can simply request retransmission of the entire data file. Any nearby UEs having data packets for the particular message can transmit those data packets thereby permitting the intended recipient to receive and reassemble the entire data message.

If the data message is an audio transmission, the UE 120 can be programmed to have a Push-to-Talk (PTT) button. For example, many “smart phones” have touch sensitive screens. A PTT button could be programmed into the touch sensitive screen. When a user presses the PTT button, an audio message is recorded and stored within the UE. When the PTT button is released, the audio message is transmitted to other nearby UEs. The audio message may be a private message for a particular recipient, a group message for a designated group of recipients, or a public message intended for any nearby recipient.

In another embodiment, a retail business may broadcast messages to nearby UEs. In an exemplary embodiment, the retail facility can set up a wireless AP (e.g., the wireless AP 140 in FIG. 3) to establish a short-range communication network 116. For example, a retail facility in a shopping mall can transmit advertisement messages to nearby UEs. In a typical embodiment, these would be public messages that are freely relayed from one UE to another and from one short-range wireless communication network 116 to another. Using this form of message distribution, an advertisement from a retail facility will soon be disseminated to all wireless users in the area. The advertisements may take the form of text messages or any other data message described above.

In another aspect, an individual user may register with a business. Whenever the user comes within range of the short-range communication network 116 associated with the retail business, message data may be exchanged thus enabling the business to identify a particular user that is nearby. In this embodiment, the retail business may send a private advertisement message to the particular user. The private advertisement may be customized for the user based on a number of factors, such as the user's profile (e.g., the sex, age, and interests of the user), prior shopping patterns, or the like. It can also be based on statistical and history data that the retail business has collected on the user in one or more short-range communication networks 116 in the region around the retail business. For example, if a particular user has registered with a restaurant and comes within range of the short-range communication network 116 of that restaurant at a subsequent time after registration, the restaurant can send a private advertisement message to entice that user into the restaurant by offering a discount on a meal previously purchased by that user. If the user is a sports enthusiast, a sports bar could send a message that a particular sporting event (e.g., the user's college football team) is ongoing and offer a discount on a meal. In this manner, highly customized advertisements may be sent to individual users.

In some situations, the user may not be within range of the short-range communication network 116 of the restaurant, but may still be nearby. Because the UEs in the various short-range communication networks 116 relay messages, any message from a particular user may be relayed to the retail business via one or more short-range communication networks 116. Thus, a business at one end of a mall may detect the arrival of a particular user at the opposite end of the mall and still transmit a customized advertisement message to that user.

As discussed above with respect to FIG. 6B, a text message may include time data and geo-location data (e.g., latitude and longitude). In yet another aspect of the system 100, a business can collect and analyze the time and geo-location data to identify patterns among users even if the user has not previously registered with the business. The business can also collect profile data transmitted by the user. The data in a text message header uniquely identifies an individual even if that individual's actual identity is unknown to the business. A business can collect data and determine, for example, that a particular user passes nearby the business every day in a particular time range. The business can broadcast a public advertisement or a private advertisement to that unknown individual based on the time and geo-location data pattern previously established. For example, a coffee shop may determine that a particular user passes by every Monday-Friday between 9:00 and 9:30 a.m. With this data in hand, the coffee shop can broadcast an advertisement message to the particular unidentified individual to invite them into the business. In one aspect of this embodiment, the business can collect and store identification data, time data, and geo-location data on an ongoing basis.

Because of the mobile nature of the UEs, any particular UE can be present in one or more short-range communication networks 116 and may readily leave one short-range UE and readily join another short-range UE.

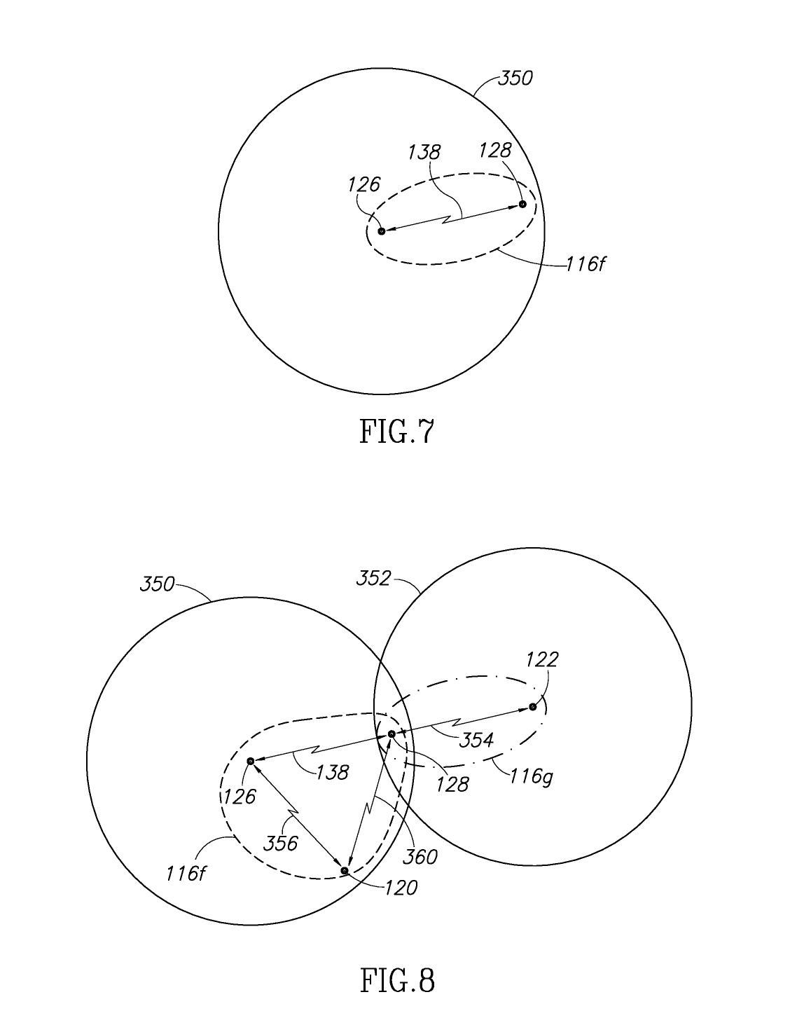

FIGS. 7-12 illustrate the distribution of message data throughout multiple short-range communication networks 116. For the sake of simplicity, the UEs are illustrated in these figures merely as dots with associated reference numbers. Furthermore, the area of coverage of UEs may be illustrated as a circle in FIGS. 7-12. Those skilled in the art will appreciate that the circle is a two-dimensional representation of the area of coverage of a particular UE. Those skilled in the art will appreciate that the UE transmits in three-dimensions and that the arc of coverage may be altered by natural or manmade barriers (e.g., terrain, plants, trees, walls, buildings, and the like). The area of coverage may even alter as the UE moves from one room to another within a building.

FIG. 7 illustrates the most rudimentary form of the short-range communication network 116. In FIG. 7, the UE 126 is illustrated at the center of a communication range 350. UEs that come within the communication range 350 may form a short-range communication network 116f. As the UE 128 moves within range of the UE 126, the wireless communication link 138 is established. As described above, the two UEs 126-128 will exchange message data. In one embodiment, each of the UEs 126-128 could exchange its complete list of message data stored within the data storage area 184. In some embodiments, only one of the mobile communication devices 126-128 transmits its message data to the other UE. The receiving UE compares the received message data with the message data stored in the data storage area 184 to eliminate duplicate messages. Duplicate messages may be identified by the individual message header that identifies the originator as well as the date/time of the message origination. In practice, either of the two UEs 126-128 could send its stored message data. To avoid inconsistencies, in one embodiment, the group owner (the UE 126 in the example of FIG. 7) is designated to receive the message data and perform the merge operation. Thus, in this example the UE 128 would transmit all of the stored message data in the data storage area 184. As discussed above with respect to FIG. 5, this may also include new messages created by the UE 128. Upon receipt, the UE 126 compares the received messages with the stored messages in the data storage area 184 to eliminate duplicates. Time stamp data, discussed above with respect to FIG. 6, can be used to identify duplicate messages. Following the message merge process, the data storage area 184 in the UE 126 will contain a merged data message file. The merged data message file is transmitted to the UE 128 for storage in its data storage area 184. Thus, the data storage area 184 in each of the UEs 126-128 is now synchronized. This illustrates a Data Exchange Process (see FIG. 5) to synchronize the data storage areas 184 between two UEs in a particular short-range communication network 116. If the short-range communication network 116 includes more UEs, they will undergo the Data Exchange Process such that all UEs in a particular short-range communication network are synchronized (i.e., they have the same data in their respective data storage areas 184).

FIG. 8 illustrates the UE 122 at the center of a communication range 352. As illustrated in FIG. 8, the UE 122 comes within range of the UE 128 (by movement of one or both UEs). In a process described above, a wireless communication link 354 is established between the UEs 122 and 128. In one embodiment, the UEs 122 and 128 form a short range communication network 116g. In this embodiment, the UE 128 is in both the short-range communication network 116f and 116g. The UEs 122 and 128 exchange message data in the manner described above. At the end of the message exchange process, the UEs 122 and 128 will be synchronized. Because the UE 128 now has updated message data resulting from the synchronization with the UE 122, the Data Exchange Process (see FIG. 5) between the UEs 126 and 128 will also occur again. Thus, at the end of this synchronization process, the UEs 122, 126, and 128 will all have the same message data in the data storage area 184 (see FIG. 2). It should be noted that the data storage area 184 need not be identical between the UEs 122, 126, and 128 because the messages may appear in a different sequence. However, following synchronization, the data storage area 184 in each of the synchronized UEs will contain the same messages.

In an alternative embodiment, the UE 128 acts as a repeater to relay communications such that the UE 122 is effectively part of the short-range communication network 116f. It should be noted that Direct Messages (i.e., messages intended for a specific recipient) may be passed along a number of different UEs in a number of different short-range communication networks 116. Security measures, such as encryption, prevent viewing of messages by any UE (or any access port of router) except the intended recipient.

FIG. 8 also illustrates the UE 120 coming within range of the UE 126. As described above, a communication link 356 is established between the UEs 120 and 126. In addition, if the UE 128 is within range of the UE 120, a separate short-range wireless communication link 360 may be established between the UEs 120 and 128. As described above, when the UE 120 becomes part of the short-range communication network 116f, data in the data storage area 184 (see FIG. 2) of the UE 120 is exchanged between the UE 120 and other UEs already in the short-range communication network 116f. In the embodiment illustrated in FIG. 8, data may be exchanged between the UEs 120 and 126 via the wireless communication link 356. Because the UE 126 now has updated data in the data storage area 184, synchronization will occur between the UEs 126 and 128. Again, following the synchronization process, the data storage area 184 in the UEs 120, 126, and 128 will contain the same messages. Because of the new data in the data storage area 184 of the UE 128, a new synchronization process will occur with the UE 122. Thus, in a short period of time, all the UEs in the short-range communication networks 116f-116g are synchronized.

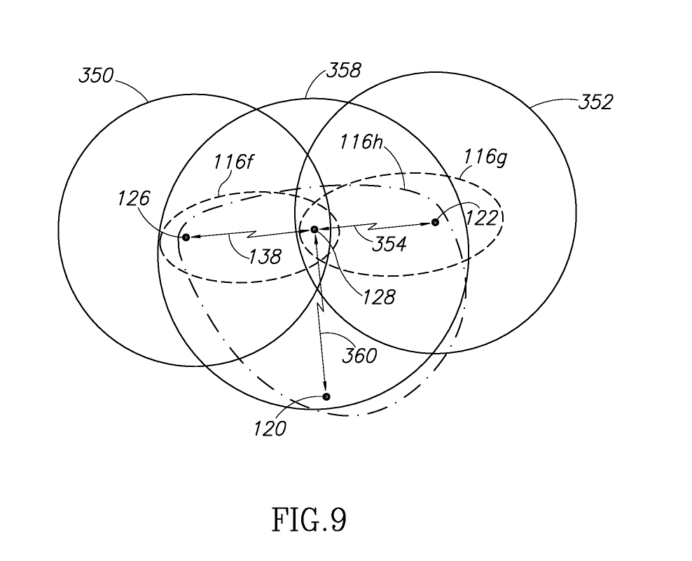

To illustrate the dynamic nature of the short-range communication networks 116, consider FIG. 8 where the UE 120 now moves out of range of the wireless communication 126, thus eliminating the wireless communication link 356. However, in the embodiment illustrated in FIG. 9, the UE 128 is illustrated at the center of a communication range 358. As the UE 120 moves out of the communication range 350, it moves into or remains within a communication range 358 of the UE 128. As described above, the wireless communication link 360 is established between the UEs 120 and 128. FIG. 9 illustrates that the short-range communication network 116f now includes only the UEs 126-128 while the short-range communication network 116g includes only the UEs 122 and 128. In one embodiment, the UE 120 may become part of the short-range communication network 116f, or the short-range communication network 116g, or both by using the UE 128 as a relay. In an alternative embodiment, the UE 128 may become the group owner of a new short-range communication network 116h that includes the UEs 120, 122, 126 and 128. In this embodiment, the new short-range communication network 116h eliminates the need for the short-range communication networks 116f and 116g. Thus, the short-range communication networks 116f and 116g would be eliminated.

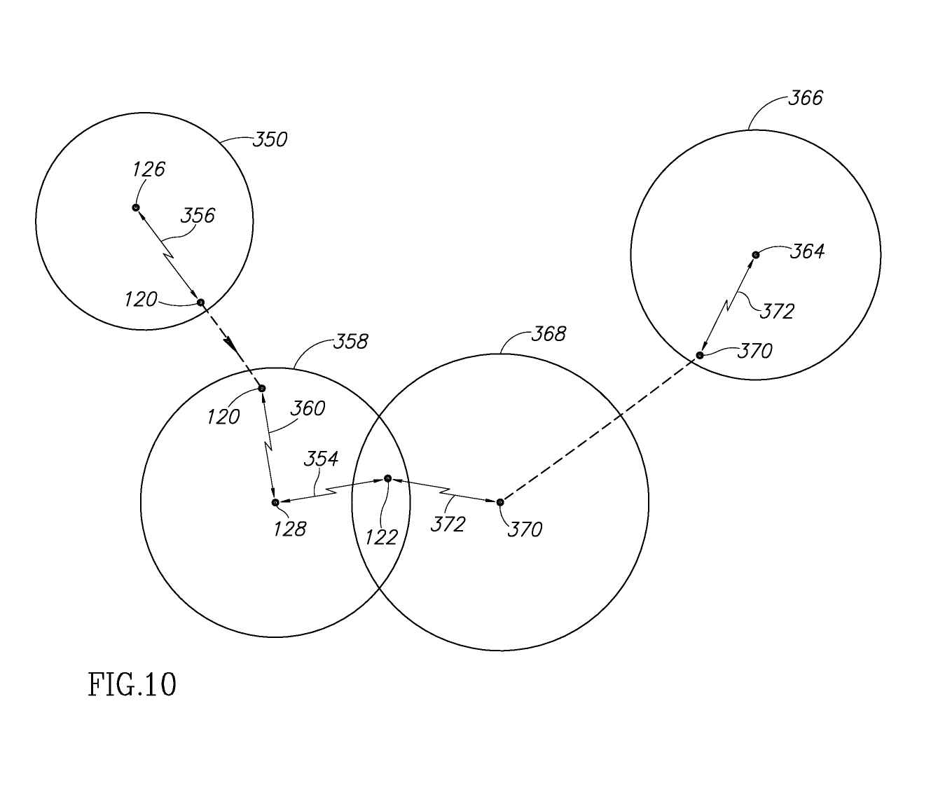

FIG. 10 illustrates a scenario in which UEs travel from one short-range communication network 116 to another and thereby distribute data stored in the data storage area 184 of the traveling UE. In FIG. 10, the UE 126 may generate a message for a UE 364 having an area of coverage 366 that does not overlap with the communication range 350 of the UE 126. In the example illustrated in FIG. 10, a message is contained within the data storage area 184 of the UE 126. The message may have been generated by the UE 126 or may have been received by the UE 126 from another UE (not shown). The UE 126 uses the wireless communication link 356 to exchange data with the UE 120. In the example illustrated in FIG. 10, the UE moves out of the communication range 350 and into the communication range 358 of the UE 128. In the present example, there may be a period where the UE 120 is not within range of any short-range communication network 116. However, as the UE 120 moves within the coverage range 358, it establishes the wireless communication link 360 with the UE 128 and exchanges data therewith in the manner described above. In turn, the UE 128 exchanges data, including the data carried by the UE 120, with the UE 122 using the wireless communication link 354.

As FIG. 10 illustrates, the UE 122 is within a communication range 368 of a UE 370. The UE 122 exchanges data, including the data originally carried by the UE 120, to the UE 370 using a wireless communication link 372. In the example of FIG. 10, the UE 370 moves out of range of the UE 122 and out of the communication range 358. At some later point in time, the UE 370 moves within the communication range 366 of the UE 364, which is the intended recipient of the message originally stored in the data storage area 184 of the UE 126. At this point, the UE 370 establishes a communication link 372 with the UE 364. At that point, the UE 370 exchanges data in the data storage area 184 (see FIG. 2) with the UE 364. As previously discussed, the UE 370 is carrying the data originated by the UE 126. This is true even though the UE 370 may have been out of range of any UEs for some period of time. Following the data exchange between the UEs 370 and 364, the UE 364 now includes the data originally stored in the data storage area 184 of the UE 126. Thus, it can be appreciated that the dynamic and fluid nature of the short-range communication networks 116 allows data to be exchanged between UEs that are in range of each other and for data to be carried from one short-range communication network 116 to another.

The example illustrated in FIG. 10 shows only a single UE 120 moving from the communication range 350 to the UE 358, the single UE 370 moving from the area of coverage 368 to the area of coverage 366. However, those skilled in the art will appreciate that this scenario can be repeated by dozens of UEs. Using the example of a shopping mall, data may be originally exchanged between dozens of UEs within a single short-range communication network 116. As each of those dozens of UEs fan out, they temporarily become members of other UEs and disseminate the data stored in their respective data storage areas 184 to potentially dozens of other UEs within the new short-range communication network. This form of “viral” distribution can effectively provide a mesh network in areas where there is a large accumulation of UEs. Thus, the data from the UE 126 in the example of FIG. 10 may, in fact, be delivered to the UE 364 through a multitude of pathways.

FIG. 10 illustrates the movement of mobile communication devices from one short-range communication network 116 to another. Those skilled in the art will appreciate that the distances between short-range communication networks 116 may be considerable. Messages could be relayed from one UE to another and from short-range communication device to another. When a UE is temporarily out of range of a short-range communication network 116, that wireless device will carry the messages stored in the data storage area 184 (see FIG. 2) until it comes in contact with another short-range communication network. At that point, the message data will be transferred to other UEs in that short-range communication network 116 and each of those UEs will carry the message further until it reaches its intended recipient. Thus, a message could be carried a few feet to its intended destination or a few hundred miles to its destination.

When a large number of conventional UEs are in physical proximity, such as a sporting event or even in rush-hour traffic, a conventional communication network is often overwhelmed because many UEs are attempting to connect to the same base station. Thus, too many conventional mobile communication devices in proximity can be a debilitating situation. In contrast, the system 100 can actually take advantage of the presence of a large number of UEs because a large number of devices will facilitate the movement of messages independent of the conventional service provider network. Thus, the system 100 can facilitate rather than debilitate communication in the presence of a large number of mobile communication devices. For example, a message generated by one user in rush-hour traffic will be quickly relayed to many other UEs in the same rush-hour traffic. Thus, messages may move quickly up and down a roadway. In addition, some of the UEs will become part of short-range communication networks in other locations near the roadway. Thus, the message spreads up and down the roadway using the UEs in automobiles on the roadway and moves away from the roadway as automobiles enter and leave short-range communication networks adjacent to or near the roadway. The system 100 could move a message from, by way of example, Orange County to Los Angeles using a variety of short-range communication networks in the manner described above.

As previously discussed, messages may be categorized in several categories, such as Public Messages, Group Messages, Direct Messages, and Status Messages). In addition, a priority category may be created to disseminate emergency messages. The example of FIG. 10 illustrates one embodiment in which an emergency message may be generated by the UE 126 or received by the UE 126 from another UE (not shown). The emergency message can be disseminated to the recipient (e.g., the UE 364 in FIG. 10) in the manner described above with respect to FIG. 10. One distinction between an emergency message and other message types is that an emergency message will not be deleted from the data storage area of any UE until “Message Received” confirmation message is received or until some instruction is received to delete the emergency message from the data storage area 184. In this embodiment, the emergency message may be distributed in the same fashion described above with respect to FIG. 10. When the emergency message reaches its intended recipient (e.g., the UE 364), the recipient UE generates a message received or message receipt and transmits it back to the originator (e.g., the UE 126 or UE not shown). Because of the dynamic nature of the short-range communication networks 116, the Message Received will likely be distributed via a different pathway with a different set of UEs in different sets of short-range communication networks 116. As the Message Received is distributed, each UE uses the Message Received to delete the emergency message from the data storage area 184. If a particular UE never received the emergency message, the Message Received may be ignored. Alternatively, the Message Received message can be delivered via the network 110 (see FIG. 1). For example, the UE 364 may receive the emergency message and generate the Message Received message for transmission via one or more short-range communication networks 116. Additionally, the UE 364 may send the Message Received message via the network 110. The Message Received message may be delivered to the network 110 via the AP 140 (see FIG. 3) or via another UE having network access or via a base station (e.g., the base station 104 of FIG. 1) and a gateway (e.g., the gateway 108 in FIG. 1). The Message Received receipt can be delivered to the originator of the emergency message or delivered to the individual web page 208 or individual JUMMMP web page 202 (see FIG. 3) to notify the message originator that the message has been received.

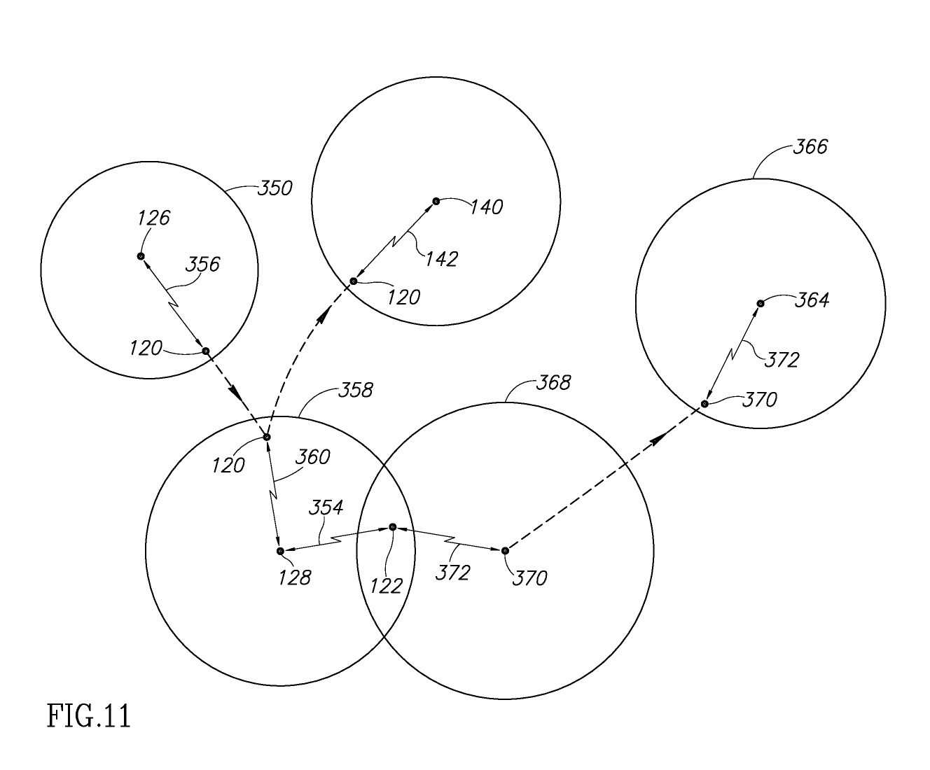

A different emergency message scenario is illustrated in FIG. 11. In this scenario, the system 100 may use the network 110 (see FIG. 1) to further disseminate an emergency message. In FIG. 11, the UE 120, which has already migrated from the communication area 350 to the communication area 358 now migrates again and comes within range of the AP 140. As described above, the wireless communication link 142 is established between the UE 120 and the AP 140. In one embodiment, the AP 140 may be part of one or more short-range communication networks 116 and further disseminate the emergency message in a conventional manner. Alternatively, the AP 140 may be a gateway to the network 110 to permit dissemination of the emergency message via the network 110. In this embodiment, the emergency message may require additional headers to identify the recipient. Thus, the wireless AP 140 and network 110 may be used to disseminate the emergency message.

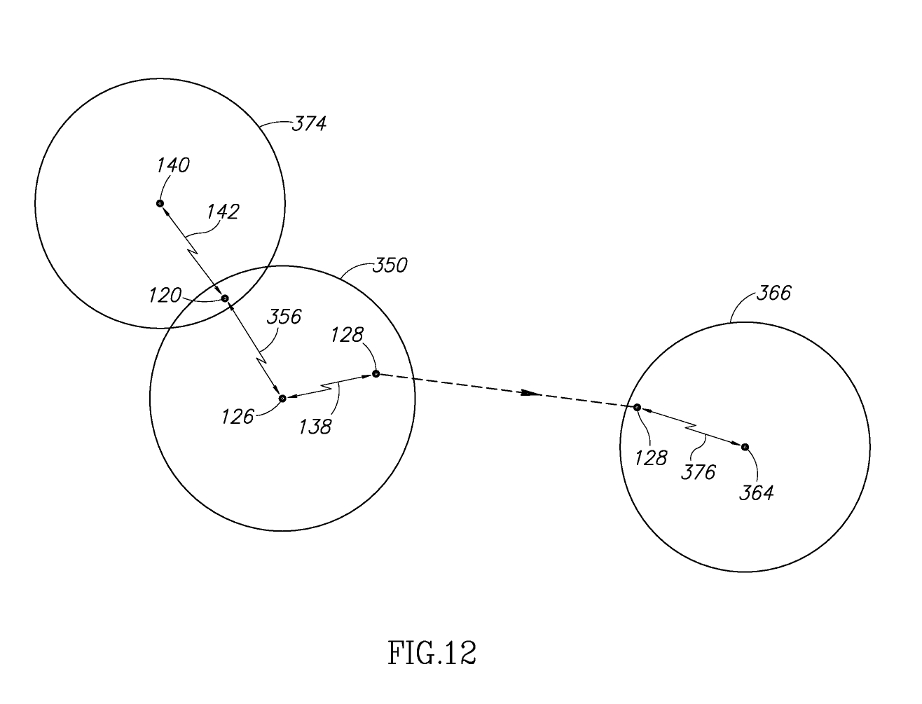

In another example application of the system 100, a business may utilize the short-range communication networks 116 to disseminate business information in the form of messages, coupons, advertisements, and the like. This is illustrated in FIG. 12 where the AP 140 may be a router or Wi-Fi AP associated with a business. A computing device (not shown) associated with the business transmits the necessary business messages to the router 140. As illustrated in FIG. 12, the UE 120 is within a coverage range 374 of the AP 140. The business messages are exchanged between the AP 140 and the UE 120 via the wireless communication link 142. At the same time, the UE 120 is within the coverage range 350 of the UE 126 when the business messages are received by the UE 120, there is a subsequent exchange of data with the UE 126 via the wireless communication link 356. At the same time, or at some subsequent point in time, the UE 128 comes within the coverage range 350 and establishes a communication link 138 with the UE 126. While within the coverage range 350, the UEs 126-128 will synchronize the data storage areas 184, thereby disseminating the business messages from the UE 126 to the UE 128. Broader dissemination through wireless links may be realized in the manner discussed above with respect to FIGS. 10-11. In the example illustrated in FIG. 12, the UE 128 travels outside the communication range 350. There may be some period of time where the UE 128 is not within the coverage range of any other UEs. At some point in time, the UE 128 travels within the area of coverage 366 as the UE 364. A wireless communication link 376 is established there between. The UEs 128 and 364 exchange data from the data storage area 184 of each device. In this manner, the original business messages are delivered to the UE 364. Thus, the business messages may be disseminated quickly by a large number of UEs (not shown) within the short-range communication networks 116. In addition, UEs, such as the UE 128 may be physically carried out of communication range of any other UE and, when connections are reestablished with another UE, the business messages are disseminated.

In another alternative embodiment, the user of a UE 120 may express personal preferences for shopping. For example, the user of the UE 120 in FIG. 12 may be interested in men's clothing. The preferences are broadcast by the UE 120 to the AP 140. The preference may include not only the general preference for men's clothing, but other options, such as particular items of clothing, sizes of clothing, colors, and the like. In this example, the AP 140 relays the customer preference data to a computer (not shown). The computer compares customer preferences with available stock or preference for sale items, and the like and returns that information to the AP 140. The AP 140 exchanges data in the data storage area 184 with the data in the data storage area 184 of the UE 120. In this manner, the UE 120 receives data relating specifically to the user's preferences.

Those skilled in the art will appreciate that other user preferences may be supplied in the form of a user preference profile. In this embodiment, the profile may include information, such as age, business and recreational interests, and the like. Based on the preference profile, the AP 140 can provide business messages customized for an individual user.

The system 100 described above exchanges messages between a number of UEs. In the example of a shopping mall, there may be hundreds of messages generated that are distributed through hundreds of other phones. Those skilled in the art will appreciate that such a large potential cache of messages requires message management. In one embodiment, the controller 182 (see FIG. 2) manages the data storage area 184 by eliminating the oldest messages as new messages are received that exceed some threshold storage level. For example, the data storage area 184 may have a certain capacity. However, it may desirable to reserve at least a portion of that capacity for emergency messages, status messages, and the like. Therefore, a threshold, which may be a percentage of the total storage capacity of the data storage area 184 can be set by the user of the individual UE or set system-wide as part of the JUMMMP API. When the threshold is exceeded, the controller 182 begins to delete the oldest messages first. In another alternative embodiment, messages may be deleted on the basis of message type. For example, business messages may have a lower priority and be deleted first. In contrast, emergency messages may not be deleted until a specific instruction is received to delete the emergency message or until a Message Read Receipt is received. Message management in a very large network may be handled on the basis of a number of parameters, including, but not limited to:
1. personal preferences;
2. personal profile;
3. message transfer to an external data structure via, by way of example, the network 110 using either WiFi and/or a conventional wireless communication link (e.g., 3 G, 4 G, LTE, or the like);
4. message pruning;
5. management of different group connections based on movement in and out of the groups; and
6. overall message management based on other parameters of multiple short-range communication networks 116.

Other message management techniques may also be used.

Those skilled in the art will appreciate that the memory capacity of UEs generally increases significantly with each new model or generation of devices introduced to the public. Although the description herein has focused on text messages, increases in storage capacity of the data storage area 184 may allow the dissemination of voice messages or even video messages. The message dissemination occurs in the manner described above. It is only the type of message that differs in this scenario. One advantage of the system 100 is that messages can be delivered even if the recipient UE is not powered or is temporarily out of range of any other UEs. This feature is advantageous in an emergency situation. For example, firefighters typically use cellular communication devices with a PTT technology that allows any one firefighter to push the button and talk to other firefighters in a designated communication group. However, if one or more firefighters are temporarily out of range of the transmitting PTT device, those firefighters will not receive the broadcast. In contrast, the system 100 can disseminate voice messages throughout all group members. Thus, a firefighter that was temporarily out of communication will resynchronize the data storage area 184 upon reconnection to any of the UEs within the firefighter group and thereby receive the original message.

The preceding material has discussed the dynamic nature of the short-range communication network 116. With reference to those figures and additional figures, network formation and network management may now be discussed in greater detail.

With reference to FIG. 1, the base station 104 is part of a mobile network and is controlled by the BSC 106. The BSC 106 may control other base stations (not shown). In turn, the BSC 106 is controlled by other network management elements. Ultimately, a large public land mobile network (PLMN) is controlled by regional or national control elements (not shown). Thus, the PLMN has a hierarchical network management system with area control elements, regional control elements and national control elements.

Because of the ad-hoc nature of the short-range communication network 116, central network control elements are not practical. Instead, each UE (e.g., the UE 120) must provide a certain degree of network management control. In addition, the UEs within a single short-range communication network (e.g. the short-range communication network 116e of FIG. 4) can provide network management for that small short-range communication network. Thus, the system 100 does not have a large centralized network management element, as is typical in wireless communication networks.

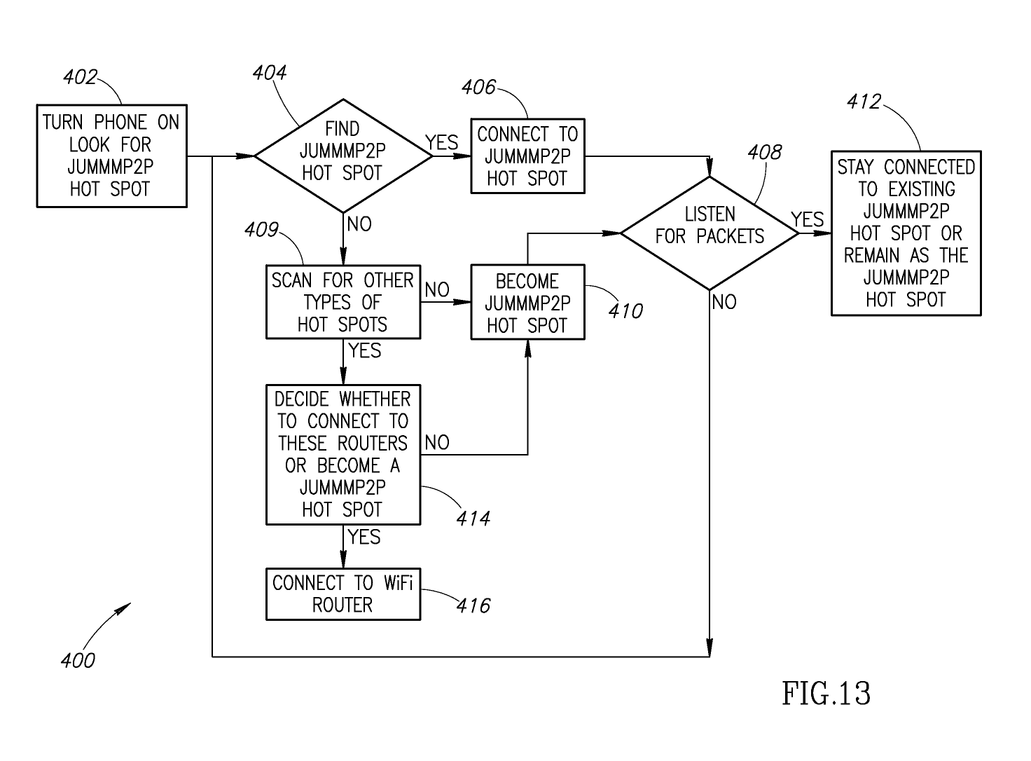

FIG. 13 illustrates a flow chart 400 illustrating an exemplary embodiment of self-management by individual ones of the UEs (e.g., the UE 120). At step 402, the user turns on or otherwise enables the short-range transceiver 176 (see FIG. 2) and the UE searches for a hot spot. Those skilled in the art will appreciate that the term “hot spot” may typically refer to the AP 140. However, in the present embodiment, a hot spot refers to any wireless device (e.g. the AP 140 or any UE) that is configured to broadcast a beacon signal identifying the device as available for communication with other UEs. In the example described above, a wireless hot spot is configured to transmit a beacon signal containing the SSID “JUMMMP.” In this exemplary embodiment, the UE searches for a hot spot transmitting the SSID “JUMMMP.”

In decision 404, the UE (e.g. the UE 120) determines whether it has discovered a JUMMMP hot spot. If the UE has discovered a JUMMMP hot spot, the result of decision 406 is YES and, in step 406, the UE connects to the discovered hot spot.

In decision 408, the UE listens for data packets to determine whether any data packets are available from the discovered hot spot. If data packets, such as messages, are available from the discovered hot spot, the result of decision 408 is YES and, messages are exchanged between the UE and the hot spot. An example data exchange process is described above with respect to FIG. 5.

Returning to decision 404, if the UE (e.g. the UE 120) is unable to detect a JUMMMP hot spot, the result of decision 304 is NO and, in decision 409, the UE scans for other types of hot spots other than a JUMMMP hot spot. If no other type of hot spot is available, the result of decision 409 is NO, and in step 410, the UE itself becomes a hot spot. In operation, the UE is configured to transmit a beacon signal and will serve as a hot spot for other nearby UEs. In the example presented herein, the UE that becomes a hot spot will transmit a beacon signal with the SSID JUMMMP.

Following step 420, the UE/hot spot also listens for data packets in decision 408. In this implementation of decision 408, the UE/hot spot is listening to detect other UEs that may attach thereto. When another UE (e.g. the UE 122 in FIG. 4) detects the UE/hot spot, it will establish a communication link therewith and exchange messages. If data packets are to be exchanged, the result of decision 408 is YES.

In an exemplary embodiment, the UEs will continue to operate as the short-range communication network 116 so long as the UEs are connected to a hot spot. As discussed above, the hot spot may be a router, wireless AP, or another one of the UEs. In step 412, the UE will stay connected to the existing JUMMMP hot spot or will remain as the JUMMMP hot spot so long as other devices are connected therewith to form the short-range communication network 116.

In an alternative embodiment, the controller 182 (see FIG. 2) may include a timing element that will cause the UE (e.g., the UE 120) connected to a hot spot to periodically disconnect from that hot spot and scan for other JUMMMP hot spots even if the result of decision 408 is YES. If another JUMMMP hot spot is discovered by the UE as a result of implementation of this search, the UE can execute step 406 to connect to the new JUMMMP hot spot. The UE will execute other steps as described above with the new hot spot to exchange data (e.g., messages) and to synchronize the data storage area 184 of each UE within the particular short-range communication network 116.

Returning to decision 408, if no data packets or messages are detected by the UE connected to a JUMMMP hot spot, the result of decision 408 is NO. In that event, the UE ceases communication with that hot spot and scans for a different JUMMMP hot spot in decision 404. If a different JUMMMP hot spot is detected, the result of decision 404 is YES and the system 100 returns to step 406 to connect to the newly discovered JUMMMP hot spot and will exchange messages therewith in the manner previously described.

Returning to decision 409, if the UE detects other types of hot spots, the result of decision 409 is YES. In that case, the UE moves to decision 414 to determine whether to connect to the non-JUMMMP hot spot or to become a JUMMMP hot spot. The UE may elect to connect to a non-JUMMMP hot spot in order to gain access to a router or other gateway device. If the UE decides to connect to the non-JUMMMP hot spot, the result of decision 414 is YES and, in step 416, the UE connects to the WiFi router or other device, such as a wireless modem or other AP. If the UE decides not to connect to the non-JUMMMP hot spot, the result of decision 414 is NO and the UE becomes a JUMMMP hot spot in step 410.

Thus, a UE in the embodiment of FIG. 13 will remain connected to a JUMMMP hot spot so long as they remain within range of each other and continue to exchange data. Even though it may be connected to a JUMMMP hot spot, a different UE will disconnect and scan for other JUMMMP hot spots if no data is being received from the present JUMMMP hot spot or may periodically disconnect from the present JUMMMP hot spot to search for other nearby JUMMMP hot spots. Furthermore, those skilled in the art will appreciate that mobile devices may change location. A user may be temporarily stationary or may be walking or riding in a vehicle. Thus, UEs may move in and out of range of a JUMMMP hot spot on a relatively frequent basis. Similarly, a UE serving as the JUMMMP hot spot may itself be mobile and move out of range of other UEs within the dynamically formed short-range wireless communication network. Thus, each UE manages its own activities and can connect or disconnect from JUMMMP hot spots or, in the absence of another JUMMMP hot spot, may be configured to become a JUMMMP hot spot so that others may connect to it.

During the operational set-up of a short-range communication network 116, the designated hot spot (e.g., the AP 140 or any UE, such as one of the UEs 120-128) transmits the designated SSID, as described above. The hot spot device assigns a MAC address to each UE attempting to connect to the hot spot. In an exemplary embodiment, each of the UEs within a particular short-range communication network 116 is assigned the same MAC address. This will permit the free exchange of communications among the UEs of the short-range communication network 116.

As discussed above, a new UE that discovers a hot spot will associate with that hot spot and exchange data messages, as illustrated in FIG. 5. However, UEs within a short-range communication network can exchange messages directly. For example, FIG. 8 illustrates the UE 126, which may serve as the group owner or hot spot for the short-range communication network 116f. In one embodiment, the UEs 120 and 128 may exchange message data via the UE 126. However, the UEs 120 and 128 may also exchange messages directly with each other via the wireless communication link 360. This is true even if the UE 126 moves out of range of the UEs 120 and 128 or is powered down. Even if the group owner or hot spot disappears, UEs 120 and 128 can still communicate with each other as part of the short-range communication network 116f. Thus, the hotspot 126 is only necessary to initiate formation of the short-range communication network 116f. If the hot spot 126 disappears, the short-range communication network 116f will continue to operate, but will not be detected by other nearby UEs because no communication device in the short-range communication network 116f is broadcasting the SSID JUMMMP. Alternatively, the short-range communication network 116f may merge into the short-range communication network 116g.

In yet another alternative embodiment, the UE 128 effectively links together the short-range communication networks 116f-116g. That is, all messages in the data storage area at 184 (see FIG. 2) of the UEs 120 and 126 will be provided to the UE 128 during the synchronization process described above. In turn, the UE 128 will synchronize its data storage area 184 with the data storage area 184 of the UE 122. Thus, the UE 128 effectively bridges the UEs 120, 122, and 126 thereby creating a single larger short-range communication network 116 out of the smaller short-range communications networks 116f and 116g.

Although FIG. 8 illustrates only a small number of UEs within the short-range communication network 116f, those skilled in the art will appreciate that the principles described herein can be extended to a greater number of UEs. Thus, many UEs within a short-range communication network 116 can continue to communicate with each other and maintain the short-range communication network 116 even if the group owner subsequently disappears (by moving out of range or powering down the device).

In the embodiment described above, there must be at least one hot spot (i.e., a group owner) to initiate the formation of a short-range communication network 116. In a sparsely populated area (i.e., very few UEs) it is possible that two UEs are turned on and are not within range of any other UEs, including each other. In such a scenario, each UE would become a hot spot. Because a hot spot is transmitting the SSID, it is not receiving and searching for other hot spots. In this rare situation, it is possible that the two UEs would come within range of each other, but not detect each other because they are both hot spots. In a variation to the flowchart of FIG. 13, if a UE becomes a hot spot (by executing step 410 in FIG. 13) and is undetected by any other UEs, it can periodically terminate the transmission of the beacon signal and become a normal UE searching for a hot spot. The transition from a hot spot to a conventional UE may be done periodically for a short period of time. In this manner, one UE would likely be a hot spot during the period of time in which the other UE is searching for hot spots. Thus, even in a sparse population, the two UEs would ultimately detect each other and form the short-range wireless communication network 116.

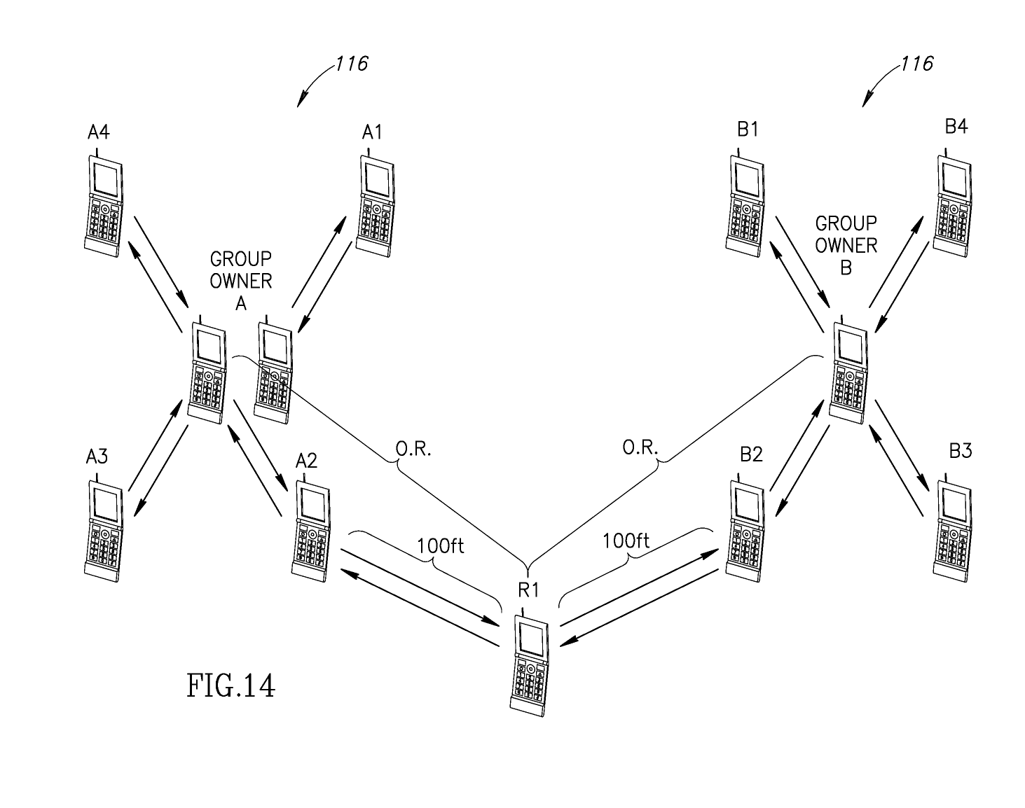

FIG. 14 illustrates other scenarios in which UEs detect hot spots or become hot spots to facilitate the formation of short-range wireless communication networks 116. In FIG. 14, there are two distinct short-range wireless communication networks 116, designated as Group A, and Group B. Group A has a Group Owner A, which serves as the hot spot and, in the example of FIG. 14, includes phones A1-A4. The UEs A1-A4 are considered peers and may communicate with each other, if in range, or communicate via the Group Owner A. Similarly, Group B includes Group Owner B and UEs B1-B4. The UEs B1-B4 are operating as peer devices and may communicate directly with each other, if in range, or communicate via the Group Owner B.

FIG. 14 illustrates the group owners (i.e., Group Owner A and Group Owner B) at the center of each respective short-range communication network 116 to illustrate the potential range of a network. However, once the peer UEs become part of a short-range communication network 116, they can freely communicate directly with other peer UEs of that network or any other short-range communication network with which they come into range. For example, the peer UEs A1 and A4 may communicate directly with each other if they move into communication range of each other.

In FIG. 14, a new UE, designated as R1, is out of range of Group Owner A and Group Owner B, but comes within range of the peer UE A2 and the peer UE B2. In accordance with the flowchart of FIG. 13, the UE R1 searches for hot spots. The UE R1 cannot communicate with either the network A or network B because it is out of range (indicated by the designation O.R.) of the hot spot (i.e., Group Owner A and Group Owner B) and therefore will not detect the transmitted SSID from the group owners. Because the UEs A2 and B2 are not hot spots, the UE R1 will be unsuccessful in locating a short-range communication network 116. In executing step 410 (see FIG. 13) the UE R1 will become a hot spot. While the UEs A2 and B2 are peers within their respective networks, they may still periodically scan for other hot spots (see step 414 in FIG. 13). When the peer UEs A2 and B2 search for other hot spots, they will detect the newly created hot spot of UE R1. As soon as the UEs A2 and B2 detect the new hot spot provided by the UE R1, the UEs R1, A2, and B2 will synchronize, as illustrated in FIG. 5. The presence of the new hot spot provided by the UE R1 effectively links together both network A and network B using the UEs A2 and B2, respectively, as bridges. Thus, all of the phones in Network A and Network B are bridged together to form a larger short-range wireless communication network. The UEs in Network A and Network B, as well as the UE R1, will all be synchronized and have exchanged messages, as illustrated in the flowchart of FIG. 5.

In the scenario of FIG. 14, network A and network B are connected together via the UE R1 with the UE R1 effectively acting as a relay between the UEs A2 and B2. However, as the UEs in the network A and the network B move around, they may come into range of each other and can therefore communicate directly with each other. For example, the peer UEs A1 and B1 in FIG. 13 may move within range of each other thus allowing direct communication between these devices.

Furthermore, those skilled in the art will appreciate that if the UE R1 came within range of only one of the peer UEs A2 and B2, the UE R1 would become a hot spot and be detected by the peer device of only one of the networks. For example, if the UE R1 became a hot spot and came within range of the UE B2, the UE B2 would act as a bridge or relay between the UE R1 and the UEs of Network B.

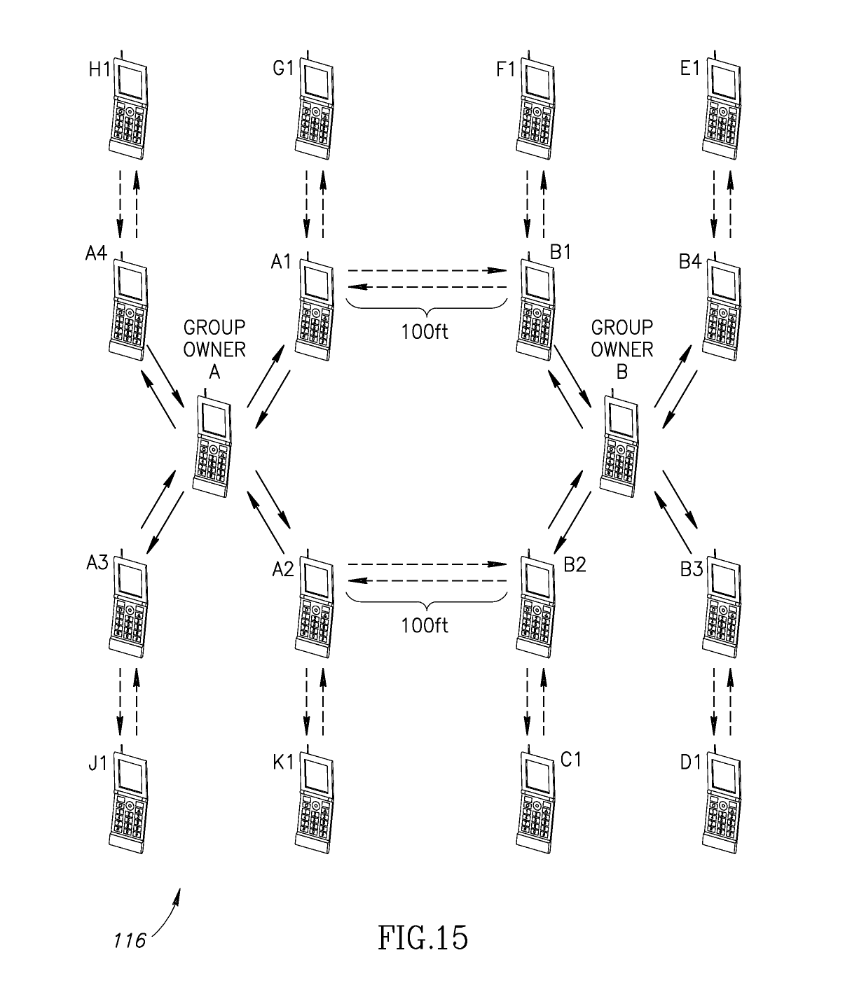

FIG. 15 illustrates a logical extension of the principles discussed with respect to FIG. 14. In the example of FIG. 15, each of the peer devices (A1-A4 of Network A and B1-B4 of Network B) searches for and connects with other hot spots (i.e., the hot spots provided by UEs C1-K1). The UEs C1-K1 may be the group owners of their respective smaller short-range wireless communication networks 116 or may be peer devices in other short-range wireless communication networks that periodically become hot spots to search for other UEs. Although not illustrated in FIG. 15, those skilled in the art will appreciate that the hot spot UEs C1-K1 may have other peer devices (not shown) connected to that hot spot thus greatly expanding the overall reach of the short-range communication network 116.

As noted above, the wireless hot spot/group owner assigns the same MAC address to those UEs that detect the SSID beacon (e.g., SSID JUMMMP). In yet another alternative embodiment, the requirement of a group owner to initiate formation of a short-range communication network 116 can be eliminated. A program designed in accordance with the present teachings can be executed and utilize a predetermined channel SSID, iprange, port, and MAC address associated with the JUMMMP functionality. A UE can simply broadcast a greeting message; if it is detected by another nearby UE, the other device can transmit its own messages thereby synchronizing the data storage area 184 (see FIG. 3) of each device. In this manner a completely de-centralized short-range communication network can be formed. The UEs detect the presence of other nearby devices by virtue of the fact that they respond to the transmission of the greeting message.

Thus, it can be appreciated that the wireless communication system described herein provides a highly dynamic network in which a large number of UEs may be coupled together in a dynamic fashion to create a large number of short-range communication networks 116 and to permit individual users to come and go from any particular short-range communication network.

While the system has been described herein with respect to Wi-Fi (i.e., IEEE 802.11), other short-range communication devices, such as Zigbee, or the like may be satisfactorily employed with the system 100.

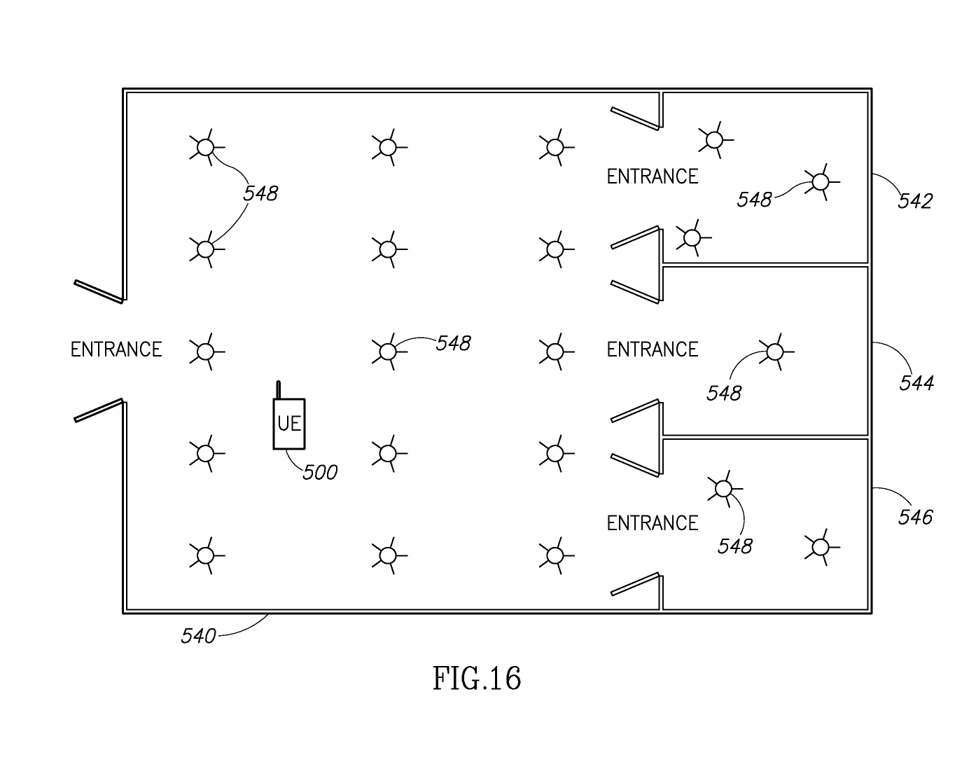

FIGS. 3 and 4 illustrate a single AP to facilitate communication between ones of the UEs. However, in some embodiments, a particular location may have a large number of APs to facilitate communication between the venue and a large number of individual UEs. FIG. 16 illustrates a large venue 540, such as a casino, sports arena, retail facility, or department store. In such a large venue, there may be related businesses 542-546 located within or near the venue 540. In the department store example, the related business 542 may be a coffee shop that is owned by the department store, or maybe an independent facility in space leased from the department store. The related business 544 may be a particular department (e.g., a shoe department) that is owned by the department store or may be an independently owned business that leases the space from the department store. The related business 546 may be, by way of example, a restaurant. Alternatively, the venue 540 in FIG. 16 may illustratively represent a shopping mall and the businesses 542-546 represent individual stores within the shopping mall. Alternatively, the venue 540 may illustratively represent a sports arena and the businesses 542-546 represent various restaurants or stores within the arena.

Due to the large size of the venue 540, it may be necessary to deploy a network of APs, illustrated by the reference number 548. The position and coverage area of the APs 548 can be determined based on the structure of the venue 540 and the particular hardware implementation. The actual distribution and installation of the APs 548 within the venue 540 is within the engineering knowledge of one skilled in the art and need not be described in greater detail herein.

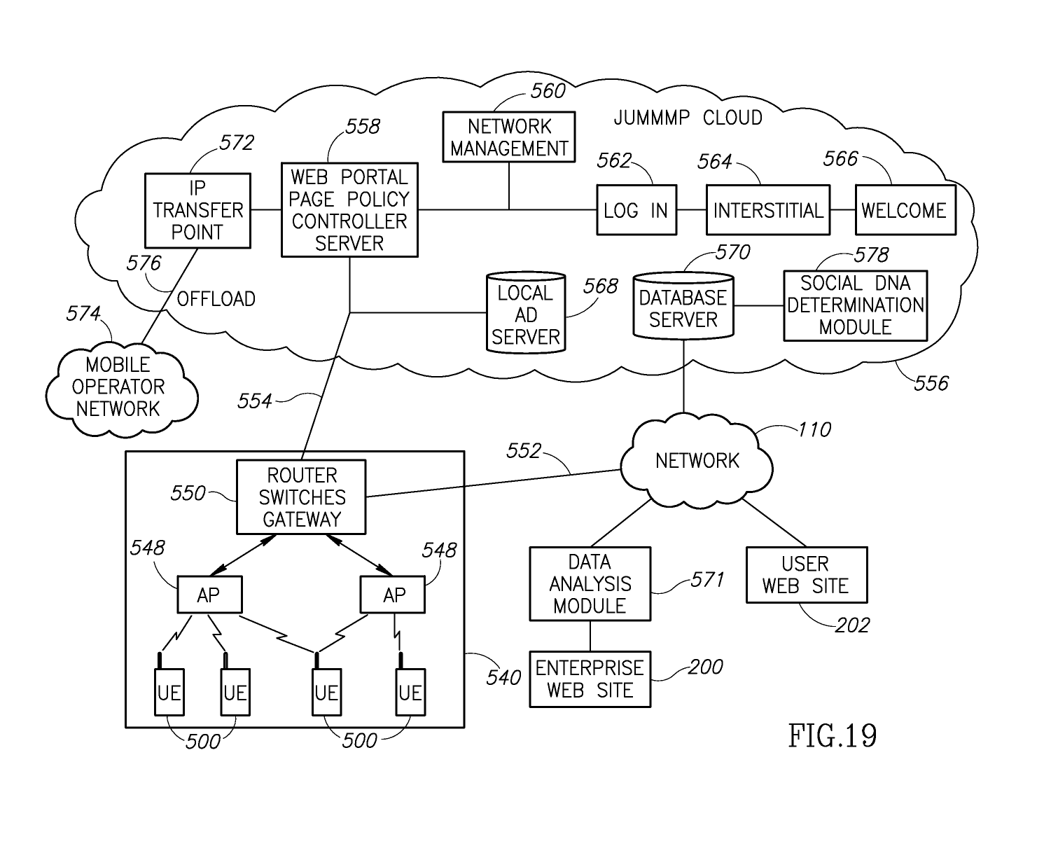

In the embodiment of FIG. 16, all of the APs 548 may be coupled to a gateway 550 (see FIG. 19). As the UE 500 moves throughout the venue 540, it is making and breaking connections between the UE 500 and one or more of the APs 548. Even though the UE 500 is making and breaking connections between specific ones of the APs 548, the UE maintains a continuous communication link with the venue 540 via the APs so long as the UE is within range of at least one AP. As discussed above, the API is a software program that aids in the authentication of the UE 500 and further facilitates communication between the UE 500 and the venue 540. The API also facilitates the exchange of Direct or Private Messages, Group Messages, and Public Messages between UEs and between the UE and an AP (e.g., one of the APs 548 in FIG. 16).

The UE 500 must perform an initial registration at some point in time. The registration process will be discussed in greater detail below. Following the initial registration process, the UE 500 can be automatically authenticated when it enters the venue 540. The authentication process will also be described in greater detail below. Once the identity of the UE 500 has been authenticated, a server 558 (see FIG. 19) can provide customized messages to the owner of the UE 500. While the UE 500 remains within the venue 540, it is in substantially continuous contact with the APs 548 and may receive data therefrom.

The venue 540 can establish virtually continuous wireless communication links with the UE 500 and provide a stream of ad content (e.g., ads, offers, discounts, etc.) for the venue 540 and the related businesses 542-546. Thus, the stream of ad data to the UE 500 may be for the venue 540 and the related businesses 542-546. Alternatively, the venue 540 may provide advertising for a different venue (not shown).

FIG. 19 illustrates a system architecture that allows operation of the system across multiple venues. In FIG. 16, the venue 540 is illustrated with a limited number of UEs 500 and a limited number of APs 548. As discussed above with respect to FIG. 16, the venue 540 may have a large number of APs 548 distributed throughout the venue. The various APs are coupled together using routers, switches, and the like. Those routers, switches and gateways are illustrated in FIG. 19 by the reference 550. Among other things, the gateway 550 allows an interconnection to the network 110 via a communication link 552, but could be any wide area network. In a typical embodiment, the network 110 may be implemented as the Internet. In addition to the communication link 552, the gateway 550 provides a backhaul 554 to a cloud computing environment designated as a JUMMMP Cloud 556. The backhaul 554 may be implemented in a variety of different manners using known technology. In one embodiment, the backhaul 554 may be routed to the JUMMMP Cloud 556 via the network 110.

Within the JUMMMP Cloud 556 are a number of components. A web portal page and policy controller server 558 controls user authentication across a number of different venues in addition to the venue 540. A network management element 560 controls overall operation of the network in the JUMMMP Cloud 556.

FIG. 19 illustrates a number of different web pages that may be downloaded to the UE 500 in the venue 540. In one embodiment, the venue 540 may include its own server and store its own portal pages. However, such an architecture requires that each venue have a separate server to support this functionality. The system in FIG. 19 advantageously utilizes the web portal page server and policy controller server 558 for multiple venues. The JUMMMP Cloud 556 may have some common pages for all venues, such as a log-in web page 562. However, even the log-in web page may be unique to the venue 540.

In addition to the log-in web page 562, the JUMMMP Cloud 556 may have one or more interstitial web pages 564. For example, interstitial web pages may display information about the venue 540 (or advertising for businesses within the venue, third party advertising, or advertising for other venues within the JUMMMP network) while the user is waiting for completion of the registration verification process. In addition, the JUMMMP Cloud 556 may include one or more welcome web pages 566. The welcome web pages 566 may offer various services, such as a credit card data entry page, and Internet access sign-up page, a voucher code entry page to permit the user to enter discount voucher data, and the like.

One skilled in the art will appreciate that the interstitial web pages 564 and the welcome web pages 566 may be unique to the venue 540. Even though these web pages may be unique to the venue, the centralized web portal page server 558 within the JUMMMP Cloud 556 simplifies the overall system architecture within the venue 540 and within other venues by eliminating the need for a portal page server within each venue.

A local ad server 568 in the JUMMMP Cloud 556 may provide ads for the venue 540. As discussed above, the ads may be for the venue 540 itself or for the related businesses 542-546 (see FIG. 16). In addition, the ads may be for businesses near the venue 540 (or for other venues in the JUMMMP network). Although the ad server 568 may be located within each venue 540, the centralized ad server 568 in the JUMMMP Cloud 556 simplifies the network architecture within the venue 540 and other venues by eliminating the need for an ad server within each venue.

A database server 570 in the JUMMMP Cloud 556 may be configured to collect a broad range of information regarding the UEs 500 (including the user profile information from the data storage area 184 (see FIG. 2) that was provided when the UE was first registered with JUMMMP Cloud 556 and/or when the UE is authenticated in the venue 540. The profile information will help provide targeting marketing and advertising to the UE 500 as it traverses the venue 540). Additional UE information, such as email address, IMEI, phone number, MAC address, etc., may be contained in the heartbeat signal that the API initiates in the UE 500, and this information may be sent and collected in the database server 570 as well.

The data collected by the database server 570 can be analyzed using data analysis module 571, which can analyze raw data using data analytics and/or data mining. Those skilled in the art will appreciate that data analytics is the science of examining raw data to draw conclusions about the information.

Data mining is a known process to identify undiscovered patterns in raw data to establish relationships based on the data. In the present context, the data analytics and/or data mining are used to analyze the movement patterns, shopping patterns, text messaging patterns, and the like. The data analytics and/or data mining can be used in conjunction with user-provided profile data to thereby establish a sophisticated user profile for individual users, groups of users, or the general public. The data analysis module 571 can operate in conjunction with data from the database server 570, or provided to a third party for analysis. In an exemplary embodiment, the resultant user profiles can be stored within the database server 570 and subsequently employed to provide customized targeted advertising to the owner of each UE 500.

The JUMMMP Cloud also includes a social DNA determination module 578 (or “social profile determination module”) configured to analyze data collected by the database server 570 relating to users social interactions and to generate a social profile or “social DNA” for the users of the system. The operation of the social DNA determination module is discussed further below.

The JUMMMP Cloud 556 also includes an IP transfer point 572, which is coupled to a mobile operator network 574 via a communication link 576. As those skilled in the art will appreciate, mobile data offloading, also called data offloading, involves the use of complementary network technologies for delivering data originally targeted for cellular networks, such as the mobile operator network 574. In areas where the cellular network traffic is heavy, congestion of the mobile operator network 574 may occur. To reduce congestion, mobile network operators sometimes set up WiFi APs in areas of congestion and allow some of the data originally targeted for the mobile operator network 574 to be carried by the WiFi network. Rules triggering the mobile offloading action can be set by an end user (i.e., the mobile subscriber) or the mobile network operator. The software code operating on the offloading rules can reside in the UE 500, in a server, or divided between these two devices. For the end users, the purpose of mobile data offloading may be based on the cost for data service and the ability of higher bandwidth. For mobile network operators, the main purpose for offloading is to reduce congestion of the mobile operator network 574. The primary complementary network technologies used for mobile data offloading are WiFi, femtocells, and integrated mobile broadcast.

In a typical embodiment, each mobile network operator has its own WiFi network to offload data that would otherwise be carried on its particular mobile operator network. In the context of FIG. 19, the APs 548 within the venue 540 do not belong to the operator of the mobile operator network 574 as is normally the case in data offloading. In the implementation described in the present disclosure, the data offloading is provided by the venue 540 through contract with the mobile operator network 574. Although FIG. 19 illustrates only a single mobile operator network 574, those skilled in the art will appreciate that it is representative of one or more mobile operator networks. In operation, each mobile operator network contracts with the venue 540, either directly or with the JUMMMP Cloud 556, to provide data offloading in the venue.

When the UE 500 enters the venue, the mobile network operator is notified and the mobile operator network 574 can determine whether or not to offload data traffic for that UE. If data offloading for the UE is approved in accordance with the rules described above, Internet access, text messaging, and even telephone calls can be provided to the UE 500 via a connection from the mobile operator network 574 through the communication link 576 to the IP transfer point 572 within the JUMMMP Cloud 556. In turn, that offloaded data is routed through the backhaul 554 to an AP 548 and ultimately to the UE 500. Similarly, outgoing data (e.g., calls, text, etc.) from the UE 500 may be routed in the reverse fashion. This approach has the beneficial effect of offloading traffic from an otherwise congested mobile operator network 574. In addition, the mobile network operator may find improved performance because direct communication with the UE 500 through a base station (e.g., the base station 104 in FIG. 1) may not work well when the UE 500 is inside a building, such as the venue 540. Thus, improved reception and reduction in network congestion are double benefits of the IP offloading provided by the JUMMMP Cloud 556.

In the embodiment of FIG. 19, the policy controller server 558 may function as an authentication server to assure the authentication of the UE 500. Those skilled in the art will appreciate that the components shown in the JUMMMP Cloud 556 are illustrated as individual elements. In one embodiment, a single policy controller server 558 may be sufficient for a large area, such as the entire country. Indeed, in some embodiments, a single policy controller server 558 may provide registration services for the entire system. However, those skilled in the art will appreciate that the policy controller server 558 may be illustrative of a number of different computing platforms designed to implement the functionality of the policy controller server. In one embodiment, there may be a policy controller server for large cities, individual states, regions of the country, or an entire country. In another embodiment, the policy controller server 558 may be implemented in a hierarchical fashion where a local or regional policy server controller 558 contains local and regional data, but may communicate with regional or national policy controller servers 558 on a higher hierarchical level. For example, if the UE 500 performs an initial registration in one city, that registration data may be stored in a local implementation of the policy controller server 558 and reported to a regional or national level of the policy controller server. In this manner, the registration data may be efficiently distributed throughout a wide area. As will be discussed in detail below, this arrangement also facilitates easy subsequent authentication of the UE 500.

The UE 500 performs an initial registration with the registration server 558 at some point in time. The initial registration can be performed remotely using, by way of example, a laptop or PC connected to the JUMMMP Cloud 556 via the network 110. In another variation, the UE can perform an initial registration as it enters the venue 540 illustrated in FIG. 19, as described above. When the UE 500 initially contacts any of the APs 548, the policy controller server 558 will not have any data related to a particular UE 500. In this case, that initial AP 548 in the venue 540 may perform an initial registration. For the initial registration, the UE 500 can connect to the initial AP 548 and provide identification information. In an exemplary embodiment, the user can complete the initial registration process by providing data, such as the telephone ID (e.g., the phone number), a device ID, a user ID, and an email address as well as other information, such as the user profile in the data storage area 184 (see FIG. 2). The user ID may be a user generated name, nickname, or the like. The device ID may vary based on the particular type of the UE 500. For example, if the UE 500 utilizes an Android™ operating system, the device will be assigned an Android™ ID. In addition, the UE 500 may typically be assigned an international mobile equipment identification (IMEI). Any of these device identifications alone may be transmitted to the registration server 558. In another alternative embodiment, a unique hash of one or more device IDs may be generated and transmitted to the registration server 558 as the device ID. The short-range transceiver 176 (see FIG. 2) may also include an identification, such as a MAC address that is unique to the UE 500. The registration data described above can be provided to the registration server 558 along with the MAC address. The registration data may be stored in association with the MAC address.

As part of the registration process, an application program interface (API) is downloaded and installed on the UE 500. As discussed above, the API provides the communication functionality to the UE 500. Alternatively, or in addition to the API, the venue 540 may download an application program to the UE 500. The application program may be stored locally within the venue 540 or downloaded from the JUMMMP Cloud 556. The application program may be unique to the individual venue or a general application program applicable across multiple venues. In an exemplary embodiment, the application software may start whenever the UE 500 turned on and runs in the background as a service in a manner similar to the API discussed above. In a manner similar to the API, the application software may be configured to send periodic heartbeat signals with location information and unique identification information to the database server 570. In return, the venue can present promotional information to the UE 500 based on the current location, the user profile, or other factors, as will be described in greater detail below.

If the short-range transceiver 176 (see FIG. 2) is not turned on, the software application program, or the API, will turn on the short-range transceiver. In an exemplary embodiment, the user may decide to turn off the short-range transceiver 176. In this case, the API or the application software program will leave the short-range transceiver 176 in the disabled state so as to avoid unnecessary or unwanted transmissions to the UE 500. However, if the user re-enables the short-range transceiver 176 or restarts the software application program, the short-range transceiver 176 will be automatically enabled.

Once the initial registration process is completed, the web portal page server 558 may transmit other pages, such as the log-in web page 562, one or more interstitial web pages 564, and the welcome web page 566 shown in FIG. 19.

The UE 500 can also perform the initial registration using a conventional wireless service provider network. As previously discussed, the UE 500 can communicate with the wireless communication network 102 (see FIG. 1) in a conventional manner. Those skilled in the art will appreciate that the UE 500 can access the network 110 via the wireless communication network 102. Conventional wireless service provider components, such as the gateway 108 to the network 110 are known in the art, and need not be described in greater detail herein. In one embodiment, the UE 500 can perform a registration process with the registration server 558 (see FIG. 19) via the wireless communication network 102. In this embodiment, the UE 500 accesses the JUMMMP Cloud 556 or a website, such as the JUMMMP network website 200 illustrated in FIG. 3. In this example, the registration server 558 may be associated with the JUMMMP network website 200 (see FIG. 3) or the JUMMMP Cloud 556 of FIG. 19. In either case, the user provides the information described above, such as the telephone ID, device ID, user ID, and the like. In addition, the user can provide profile data, such as described above.

Alternatively, the UE 500 may perform an initial registration using a conventional computer (e.g., the user computing device 112 of FIG. 1) to provide the registration data for the UE 500 to the policy controller server 558 or registration server 560 via the network 110. The user can simply send a registration request message to the policy controller server 558 and provide user information, such as user profile information, the telephone ID, User ID, and device ID associated with the UE 500. The policy controller server 558 can store the authentication information in the database server 570.

In an exemplary embodiment, a previously-registered UE 500 may come within range of any of the APs 548 in the venue 540 of FIG. 19 and establish a wireless communication link therewith. The venue 500 will automatically authenticate the UE 500 based on previously stored registration information associated with the UE.

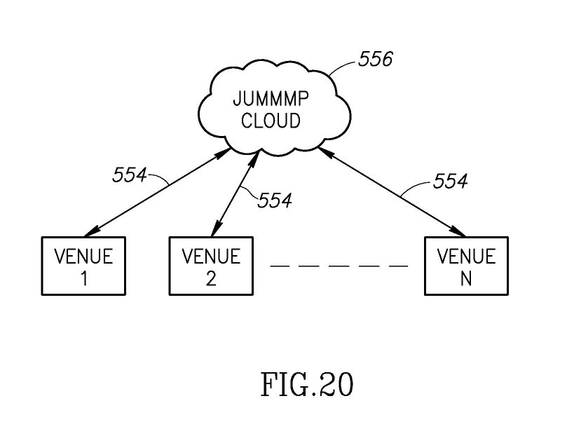

The registration process at a single venue has been discussed above with respect to FIG. 16. The JUMMMP Cloud 556 also advantageously provides a centralized registration function for multiple venues, as illustrated in FIG. 20. The multiple venues 540 are each connected to the JUMMMP Cloud 556 via individual respective backhauls 554. If a UE 500 initially registers at Venue 1, using the registration process described above, that registration information is stored in the JUMMMP Cloud 556. At a later point in time when the user enters, by way of example, Venue 2 illustrated in FIG. 20, the UE 500 will automatically identify the AP 548 in the Venue 2 as part of a JUMMMP network and begin to communicate therewith. In establishing the communication link, the UE 500 transmits its MAC address and/or other forms of identification, such as the phone ID or IMEI, the device ID, the user ID or the like, either alone or in combination. The AP 548 transmits an authentication request message to the registration server 558 to determine whether the UE 500 is a registered device. Based on the MAC address or other device identification data, the registration server 558 can confirm that the UE 500 has previously registered.

Because the UE 500 has already been registered, that information is passed along to the JUMMMP Cloud and the UE 500 is automatically authenticated for its new current location. This may occur transparently to the user. This automatic authentication process can occur even if the initial registration was in a completely different part of the country and amongst unrelated venues. The UE 500 may move from one venue 540 to another in the same city or region or may be in a completely different part of the country and be automatically identified and authenticated with APs that are part of the JUMMMP network. This convenient registration and authentication avoids the need for constantly searching for a WiFi connection as required by other systems. Based on this automatic authentication process, the UE 500 may be automatically connected to the WiFi network created by the APs 548 in the venue 540. The UE 500 may get welcome greetings from the venue and may also receive advertising, offers, discounts, and the like. Thus, a single registration process at any venue is sufficient for registration with the JUMMMP Cloud 556. Whenever the UE 500 goes into a different venue 540 that is coupled to the JUMMMP Cloud 556, the UE 500 is automatically recognized and authenticated. During the automatic authentication process, the JUMMMP Cloud 556 may provide interstitial portal pages 564 to the UE 500. Upon completion of the automatic registration process, welcome portal pages 566 may then be transmitted to the UE 500. Thus, even though the venues 1-N may be separate entities in completely different locations, they may all be considered part of a JUMMMP network because they are all coupled to the JUMMMP Cloud 556 and rely on the capabilities of the JUMMMP Cloud for at least the registration and authentication purposes. Furthermore, as described above, the venues may rely on the JUMMMP Cloud 556 to generate targeted advertising for the UE 500 based on the profile information, user location information, and the like.

In one configuration, the API, which is installed on the UE 500 as part of the verification process described above, is configured to generate a “heartbeat” signal that periodically reports location data and message data and other UE information (see above) back to the database server 570. The location data may include a time/date stamp to provide location information for the UE 500. This information can be useful for marketing purposes. The message data may include information about messages sent and received by the UE 500. This message data as well the time/date stamp, and location, is used by the social DNA determination module 578, as discussed below. Associated with the social DNA is a historical map, or path, of the UE's location and time. This is achieved through heartbeat data that contains this information that is sent back to the database server 570 on a periodic basis.

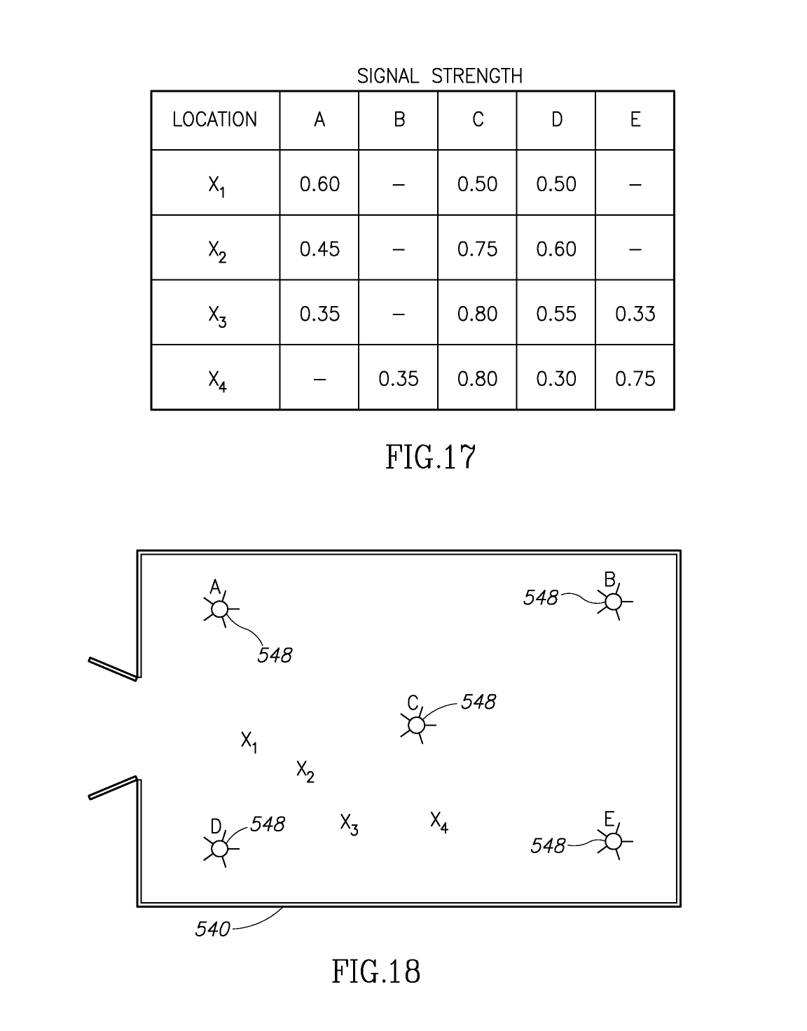

As previously mentioned, data messages may include geo-location data. The geo-location data (e.g., longitude and latitude) can be obtained in several possible ways. In one embodiment, the UE (e.g., the UE 500 in FIG. 19) may have built-in GPS. Other possible location determination technologies include WiFi, 3 G, approximation triangulation, or last-known location of the user. In reference to FIG. 17, the UE can search for signal strength of nearby APs, and can query the APs for SSIDs or the AP MAC address. This information can be part of the heartbeat signal sent back to the database server 570. Using this information, in conjunction with a map of APs in a given venue, an estimate for location can be determined for the UE 500. Other known location technologies may also be implemented in the system 100. For example, the UE 500 will communicate with different ones of the AP 548 in the venue 540 shown in FIG. 16. As the UE 500 moves throughout the venue, new communication links are established with nearby APs 548. By identifying which AP 548 the UE 500 is communicating with, it is possible to determine the location of the UE 500 with a reasonable degree of accuracy.

In an exemplary embodiment, the API in the UE is configured to do a periodic scan such that the UE can scan and record each of the SSIDs and hidden SSIDs (i.e., a BSSID) within range. For example, the UE 500 can do a WiFi scan every 60 seconds and report the location information to the database server 570 along with the heartbeat signal. In an exemplary embodiment, the UE 500 can sort the APs by signal strength. The data is reported back to any of the APs 548. Using this information, the venue 540 can determine which AP 548 is closest to the UE 500. For greater accuracy, the various APs 548 can each measure the signal strength of the UE 500 and use the relative signal strength measurements to perform a form of triangulation to determine the precise location of the UE 500. In this manner, the venue 540 can determine the precise location of the UE 500 in a particular location, such as the department, within the venue 540.

Although the venue 540 can dynamically perform triangulation measurements in the manner described above, those skilled in the art will appreciate that such calculations can be cumbersome and time consuming, particularly is the venue has a large number of UEs 500. In an alternative approach, the venue may employ a data table, such as illustrated In FIG. 17, that will simply provide the location of the UE 500 based on the signal strength measurements from various APs throughout the venue 540. In an exemplary embodiment, data for the data table in FIG. 17 can be obtained in advance by measurement device. For example, as illustrated in FIG. 18, the venue 540 has five APs 548 designated in FIG. 18 as A-E. In this example, the test measurement device may simply be a UE 500 that is configured to constantly measure the signal strength from the various APs 548 and to report those measurements back as the UE 500 moves throughout the venue 540. That is, the UE 500 is simply placed in a measurement mode and carried throughout the venue 540. For example, the UE 500 in the test measurement mode can walk down every aisle in a retail venue, using a map of the venue to identify the specific location of the test measurement UE. The UE may move from one department to another, or from one store to another if the venue 540 is, by way of example, a shopping mall. In some cases, the UE 500 in the test measurement mode may move from one level to another (e.g., using an escalator) to move among departments in the shopping venue 540.

In the example illustrated in FIG. 18, the UE 500 in the test measurement mode is moved from location X₁ to X₄, such as might be common moving down an aisle in a retail venue. At each of the locations X₁-X₄ the UE 500 in the test measurement mode measures the relative signal strength of each of the APs A-E. The system described herein may use continuous measurements from the UE 500 or take sample measurements at incremental distances from a prior measurement location. For example, the distance between locations X₁ and X₂ in FIG. 18 may be, by way of example, 10 feet. In this manner, the data table of FIG. 17 can be populated with signal strength measurements derived from the US 500 in the test measurement mode. Those skilled in the art will appreciate that the UE 500 may not receive any signal from a particular AP 548 if the signal strength is too low. In the table of FIG. 17, the UE 500 in the test measurement mode detects a signal from the APs A, C and D. No signal was detected from the APs B and E. At location X₂, the US 500 in the test measurement mode detects different signal strengths from multiple ones of the APs A-E.

As the UE 500 in the test measurement mode moves throughout the venue 540, the data in FIG. 17 provides detailed measurements of relative signal strengths at each location throughout the venue 540. In operation, the UE 500 performs the same type of measurements described above with respect to a device in the test measurement mode. However, when it reports its signal strength data, the signal strength measurements can be compared to the data in FIG. 17 to determine, for example, if the user is at approximately the location X₃, the signal strength measurements returned by the UE 500 will approximately match those values in the Table of FIG. 17.

With this data, the venue 540 can accurately track the movements of the UE 500 throughout the venue. In addition, the venue 540 can provide navigational directions throughout the venue. For example, if the consumer is in one department within the venue 540 and wishes to move to a different department (or store), the accurate location information provided by the table in FIG. 17 allows the movement of the user to be tracked throughout the venue. At an appropriate place, a text message or other Indicator (e.g., turn right in 15 feet) can be sent to the UE 500 to guide the user to the desired destination. Those skilled in the art will appreciate that the example table of FIG. 17 may be conveniently stored within the venue 540 itself, or stored on the JUMMMP cloud 556 (see FIG. 19).

The database server 570 is configured to store the location data, along with time/date data to thereby track movements of the UE 500. In one embodiment, the database server 570 can also be configured to store message data from the UEs 500 throughout the system 100. Using the example of FIG. 16, where the department store venue 540 includes a large area as well as related businesses 542-546, the database server 570 can determine how long the UE 500 remains in a particular area (e.g., one department of the department store), how many times and how long the UE remains in a department, in a restaurant, or the like. By collecting this information, the database server 570 can establish a user profile for the UE 500. In yet another embodiment, the database server 570 may also store user profiles for the UE 500 as well as profile data collected by the UE 500 from other JUMMMP users.

The customer activity within the venue 540 can be measured in a number of different ways, as described above. In an exemplary embodiment, the social DNA determination module 578 of FIG. 19 can provide an overall measure of how social particular users are. This measurement may be referred to as the user's “social DNA.” An individual's social DNA is essentially a measure of the user's social interactions with other users within one or more venues and can be based on a number of factors. The social DNA determination module 578 in FIG. 19 accumulates and analyzes various message data to generate a social DNA value for each user. A user with a high social DNA rating or score may be more interesting to other users or to the venue 540 than users with a relatively low social DNA rating.

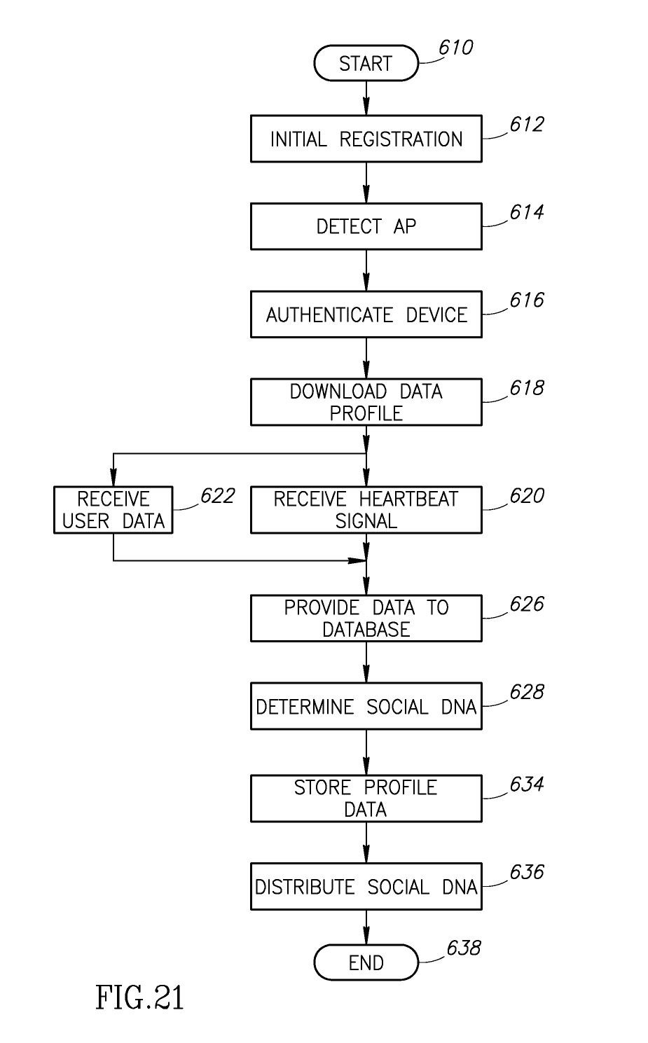

FIG. 21 is a flow chart illustrating the operation of an exemplary embodiment of the system shown in FIG. 19. At a start 610, the venue 540 has one or more APs 548 within the venue. At step 612, the UE 500 performs an initial registration. Various techniques for performing the initial registration have been described above. As part of the initial registration process, the API and/or application software program are downloaded to the UE 500. As noted above, the initial registration process need only occur a single time. In an exemplary embodiment, the initial registration data is provided to the database server 570 (see FIG. 19) in the JUMMMP Cloud 556.

Following the initial registration, the UE 500 detects the presence of one of the APs 548 in the venue 540. Upon detection, the UE 500 automatically provides identification data to the AP 548 in the manner described above. At step 616, the system can automatically authenticate the UE 500. If the venue 540 is part of the JUMMMP network, as described above, the authentication may occur using the authentication server 558 in the JUMMMP Cloud 556.

Upon authentication, the user profile for the UE 500 is downloaded from the database server 570 in step 618. Once the UE 500 is within the venue 540, it will periodically transmit a heartbeat signal including geo-location data, time stamp, and message data in the manner described above. In step 620, one or more of the APs 548 receive the periodic heartbeat signal. As described above, the heartbeat signal can be sent at convenient time intervals, such as 30 seconds, 60 seconds, 90 seconds, etc. The heartbeat signal can be sent periodically at regular intervals or irregular intervals in response to a triggering event, such as an initial authentication, connection to a new AP 548, or user activity. The heartbeat signal includes location information, and may also include user profile information and message data stored within the data storage area 184 (see FIG. 2) of the UE 500.

In addition to the heartbeat signal, the APs 548 may receive text data in step 622. Those skilled in the art will appreciate that text data can be sent at will by the user of the UE 500 and need not wait until the heartbeat signal. The text data, or any form of message data (e.g. audio, image, video, and the like), can also include location data, signed strength data, and any other component of the heartbeat signal. Thus, the heartbeat signal is intended to provide a minimum level of contact with the APs 548 in the venue 540. The UE 500 can send and receive data more frequently than the selected heartbeat rate. These various forms of data (e.g., heartbeat signal and message data) are provided to the database server 570 in step 626.

In step 628, the social DNA determination module 578 of the database server 570 determines a social DNA score or profile based on the received information. As those skilled in the art will appreciate, the downloaded profile data may already have a well-developed social DNA profile for the owner of the UE 500. The additional data collected on the present visit to the venue 540 may be used to supplement or further refine the user's social DNA profile. If the UE 500 is a first time visitor to the venue 540, the social DNA profile from the social DNA determination module 578 may have been developed from prior visits to other venues. Thus, the collection of user data associated with a particular one of the UEs 500 can be developed based on visits to multiple venues.

Returning again to FIG. 21, the social DNA profile has been determined in step 628. The social DNA profile is stored in step 634. The social DNA profile may be shared or distributed to one or more users at step 636, as described above. The social DNA profile may also be used by the venue 540 or other venues for a variety of purposes (e.g., advertising, promotions, etc.). The social DNA development process ends at 638. As noted above, the social DNA profile may be stored on the database server 570 in the JUMMMP Cloud 556. The social DNA can also be stored on a JUMMP website that the user of a UE can log into to see their text messages (public, private, and group) that were shared with other UEs in a venue 540, as well as statistics associated with their social DNA.

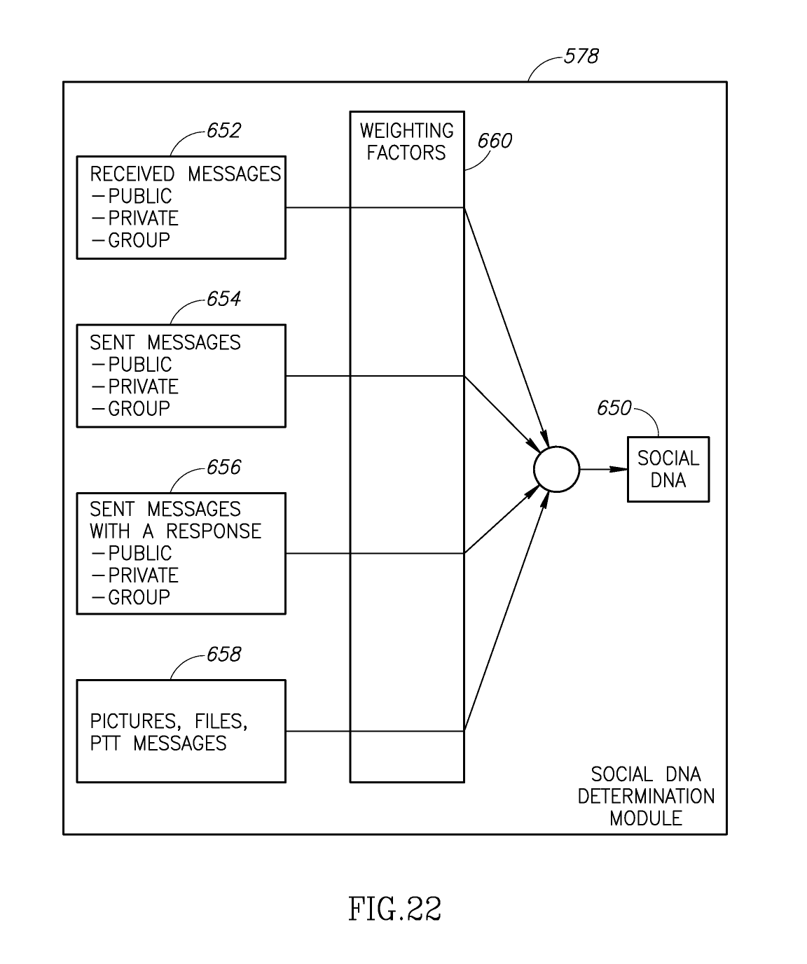

FIG. 22 illustrates an example of the analysis performed by the social DNA determination module 578 (see FIG. 19) when determining a social DNA score 650 for a user. As discussed above, the social DNA score 650 is a measure of the user's social interactions with other users within one or more venues. In this example, four input factors 652, 654, 656, 658 are weighted using weighting factors 660 and summed together to form the social DNA score 650. The four input factors are: the number and type of messages received 652; the number and type of messages sent 654; the number and type of sent messages that get a response 656; and the number of pictures, files and push-to-talk (PTT) messages sent or received 658.

For the sent and received messages input factors 652 and 654, in some embodiments the weighting factors 660 may include weighting by the type of message (e.g., public, private, group), and weighting based on the number of recipients. For example, public messages sent to a large number of recipients may be given more weight than private messages sent to a single recipient. For the sent messages that get a response input factor 656, in some embodiments the weighting factors 660 may include weighting based on the type of message, the number of people that responded to the message, and the number of recipients. For example, a message sent to 10 recipients that receives eight responses may be given more weight than one message sent to five recipients that receives one response, or one message sent to ten recipients that only receives two responses, or 10 messages sent to individuals that only receives two responses. For the pictures, files, and PTT messages input factor 658, the weighting factors 660 may include the number and type of pictures, files, and PTT messages sent or received. Of course, various combinations of input factors and weighting schemes may be used to generate social DNA scores for users.

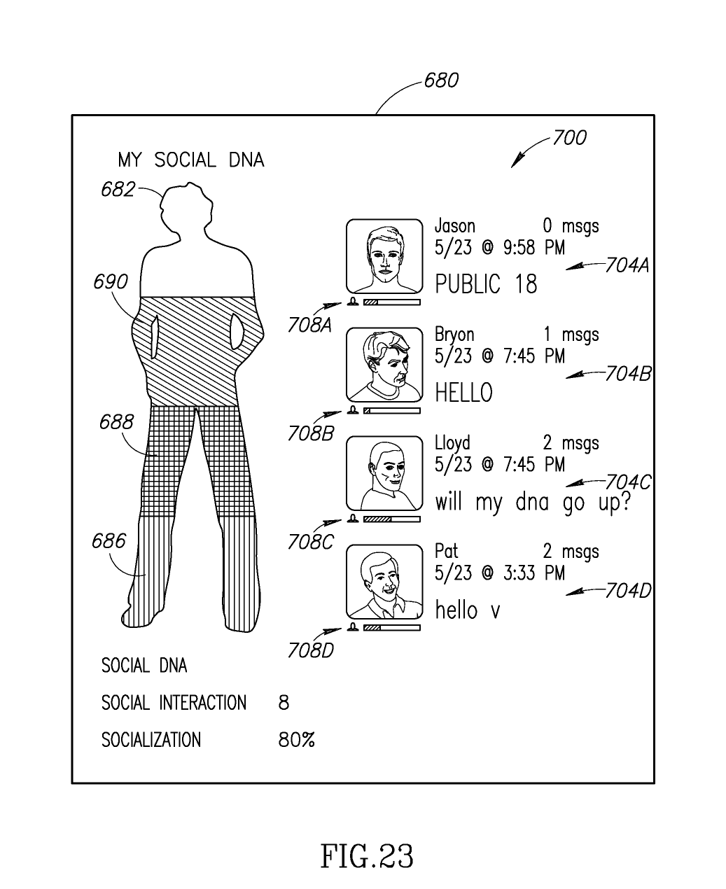

The social DNA determination module 578 can portray the social DNA rating in a variety of different manners. An example portrayal of the social DNA rating for a user is shown in a screenshot or display 680 of FIG. 23. In some embodiments, the social DNA value may be expressed on a numerical scale (e.g., from 1-10) with a value at the low end of the scale indicating a low rating for the user's social DNA while a value at the high end of the scale indicates a very high rating for the user's social DNA. In yet another embodiment, the social DNA determination module 578 can provide a graphical indication of a social DNA rating for a user. The graphical representation could be a bar graph with a higher bar graph value indicating a higher social DNA rating. In yet another alternative embodiment, color graphical representations may be used to indicate a social DNA rating. For example, a bar graph could indicate a red value for a low social DNA rating, a yellow graphical representation for a medium level social DNA rating and a green indication for a high level for the social DNA rating. In yet another embodiment illustrated in FIG. 23, the database server 570 can include a graphical outline or image 682 of a user and indicate the social DNA rating using a color scheme similar to the one described above, where the color changes from a first color 686 (e.g., red) to a second color 688 (e.g., yellow) to a third color 690 (e.g., green) as the social DNA rating increases. Those skilled in the art will recognize that other techniques may be used to provide an indication of the social DNA rating for a particular user.

In addition to providing the social DNA rating for the user, the display 680 may also include a listing 700 of members 704A-D that are nearby and connected to the system. In this example, social DNA scores 708A-D for each of the nearby members 704A-D, respectively, are shown in the listing 700. The user of the UE 500 on which the display or screen 680 is displayed may send public, private, or group messages to the members 704A-D in the listing 700 or to other registered members. The user of the UE 500 may utilize the social DNA scores of the other members to determine whether to contact them or include them in a particular group. Further, the system may utilize the social DNA scores of members when interacting with them. For example, users with high social DNA scores may be sent promotions or advertisements not sent to users with lower social DNA scores. Thus, the venue 540 can use the social DNA score 650 to determine the type of ad and frequency of ads sent to the UE 548. For example, a user with a high social DNA score 650 may receive an ad for a nightclub in a casino venue 540 while a user with a low social DNA score may receive a different ad, or none at all.

It is noted that, as described above, FIG. 23 may be part of a web site that the user logs into, which is created by collection of the heartbeat data on the database server 570. The data is then used by the social web site, in a similar manner as any social web site is used. The displayed messages can be private, public, or group, and the user can see these messages and the people that they interacted with within the venue 540, as well as their social DNA. Additionally or alternately, this can be an internal web site to the venue 540, created by collection of the heartbeat data, and viewable only by the venue to provide targeted personalized advertising as described above, as well as to provide statistics regarding quality of service, etc.

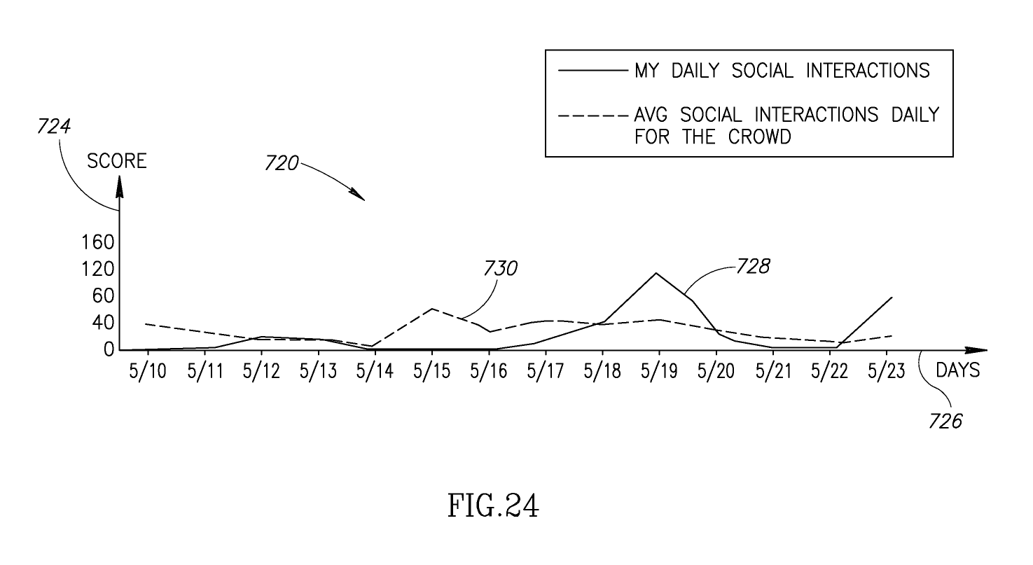

FIG. 24 illustrates a graphical representation of a user's social DNA score 728 displayed on a graph 720 of social DNA score 724 (vertical axis) versus time 726 (horizontal axis) for a period of about two weeks. The graph 720 also depicts the average social DNA scores 730 for other members so that the user may compare his or her social DNA score 728 to the social DNA scores 730 of the other members. As can be appreciated, other graphical representations may be provided or selected by the users of the system for display on the display of the UE 500.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A method for the control of a plurality of wireless communication devices in a venue using a short-range wireless communication network wherein each of the plurality of wireless communication devices includes a short-range transceiver, the method comprising:
transmitting a signal from a plurality of access points for detection by any of the plurality of wireless communications devices;
at a first of the plurality of access points, receiving an authentication request transmitted from any of the plurality of wireless communications devices that detects the transmitted signal, each authentication request including identification data associated with the wireless communication device that is transmitting the authentication request;
providing the authentication request and identification data to an authentication server to determine if the identification data matches a previously registered user;
if the authentication server determines that the identification data matches a previously registered user, then authenticating the wireless communication device associated with that user;
upon authentication of the wireless communication device, establishing a communication link between one or more of the plurality of access points and the authenticated wireless communication device;
as long as the short-range transceiver is within range of any of the plurality of access points, receiving a periodic signal transmitted from the authenticated wireless communication device using the communication link, the periodic signal including message data associated with messages sent by the authenticated wireless communication device to other of the plurality of wireless communication devices or messages received by the authenticated wireless communication device from others of the plurality of wireless communication devices; and
determining a social profile for the user of the wireless communication device within the venue by analyzing the message data included in the received periodic signal.

2. The method of claim 1 wherein the message data comprises the number of messages sent by the authenticated wireless communication device and the number of received messages by the authenticated wireless communication device during a selected period of time.

3. The method of claim 1 wherein determining the social profile comprises weighting the message data according to one or more predetermined factors.

4. The method of claim 1, further comprising sending data indicative of the determined social profile to the authenticated wireless communication device using the communication link for display on a display of the authenticated wireless communication device.

5. The method of claim 4 wherein the data indicative of the determined social profile comprises a graphic indication of the determined social profile.

6. The method of claim 1, further comprising sending to the authenticated wireless communication device data indicative of a plurality social profiles associated with users of the others of the plurality of wireless communication devices for display on the display of the authenticated wireless communication device.

7. The method of claim 1, further comprising sending data indicative of the determined social profile for the user of the authenticated wireless communication device to others of the plurality of wireless communication devices for display on a display of the others of the plurality of wireless communication devices.

8. The method of claim 1 wherein the message data comprises the types of messages sent by the authenticated wireless communication device and the types of messages received by the authenticated wireless communication device during a selected period of time.

9. The method of claim 1 wherein the message data comprises the number and type of messages sent and received by the authenticated wireless communication device, and the number of responses received to messages sent by the authenticated wireless communication device.

10. The method of claim 9, further comprising weighting the social profile dependent on the number of responses received in response to messages sent by the authenticated wireless communication device.

11. The method of claim 10, further comprising weighting the social profile dependent on the number of recipients in each of the sent messages and received messages.

12. The method of claim 1 wherein the determined social profile comprises a numerical value on a numerical scale.

13. The method of claim 1 wherein the received periodically transmitted signal comprises data indicative of a current location of the authenticated wireless communication device.

14. The method of claim 1, further comprising transmitting advertising data to the authenticated wireless communication device via the communication link with the access point, the advertising data being based on the determined social profile.

15. A method for the use of a wireless communication device in a venue wherein the wireless communication device comprises a short-range transceiver, the method comprising:
using the short-range transceiver to automatically search for an access point associated with the venue;
automatically transmitting an authentication request to a detected access point, the authentication request including identification data associated with the wireless communication device;
upon authentication of the wireless communication device, automatically establishing a communication link with the access point;
communicating with one or more other authenticated wireless communication devices using the communication link to thereby send and receive messages;
as long as the short-range transceiver is within range of the access point associated with the venue, transmitting a periodic signal comprising message data associated with the sent and received messages using the communication link to permit a social profile of the user of the authenticated wireless communication device to be determined; and
receiving data indicative of the determined social profile via the communication link.

16. The method of claim 15 wherein sending messages to one or more other authenticated wireless communication devices using the communication link comprises sending a message intended for a specified recipient.

17. The method of claim 15 wherein sending messages to one or more other authenticated wireless communication devices using the communication link comprises sending a message intended for any recipient.

18. The method of claim 15 wherein a plurality of wireless access points are associated within the venue and using the short-range transceiver to detect the wireless access point associated with the venue comprises using the short-range transceiver to detect any of the plurality of wireless access points associated with the venue.

19. The method of claim 18 wherein establishing the communication link with the access point comprises establishing a communication link with a first of the plurality of wireless access points associated with the venue, the method further comprising maintaining the communication link with others of the plurality of wireless access points associated with the venue as the wireless communication device moves out of range of the first of the plurality of wireless access points associated with the venue.

20. The method of claim 15 further comprising receiving advertising data based on the determined social profile, processing the advertising data, and displaying the advertising data on a display of the wireless communication device.

21. A system for use with a wireless communication device having a network transceiver configured for communication with a wireless service provider network and a short-range transceiver configured for communication with other than the wireless service provider network, the system comprising:
an authentication server configured to receive an authentication request from a wireless communication device and, in response to the authentication request, to verify an identity of the wireless communication device based on authentication data contained in the authentication request;
a plurality of wireless access points associated with a venue, and distributed throughout the venue, the plurality of wireless access points being configured to receive the authentication request from the short-range transceiver in the wireless communication device, a first of the plurality of wireless access points that detects the authentication request from the wireless communication device being configured to communicate with the authentication server and to provide the authentication data to the authentication server, and, if the identity is verified such that the wireless communication device is authenticated, to establish a communication link between the authenticated wireless communication device and one or more of the plurality of wireless access points such that the communication link is maintained so long as the authenticated wireless communication device is within range of at least one of the plurality of wireless access points associated with the venue;
a server coupled to the plurality of wireless access points and configured to receive periodic data transmissions from the authenticated wireless communication device via at least one of the plurality of wireless access points, the data transmissions containing message data relating to messages sent or received between the authenticated wireless communication device and others of a plurality of wireless communication devices; and
a social profile determination module configured to receive the message data and to determine a social profile for the user of the authenticated wireless communication device based at least in part on the received message data.

22. The system of claim 21 wherein the message data comprises the number of messages sent by the authenticated wireless communication device and the number of messages received by the authenticated wireless communication device during a selected period of time.

23. The system of claim 21 wherein the social profile determination module is further configured to weight the message data according to predetermined factors when determining the social profile.

24. The system of claim 21 wherein the social profile determination module is further configured to send data indicative of the determined social profile to the authenticated wireless communication device using the communication link for display on a display of the authenticated wireless communication device.

25. The system of claim 24 wherein the data indicative of the determined social profile comprises a graphic indication of the determined social profile.

26. The system of claim 21 wherein the social profile determination module is further configured to send to the authenticated wireless communication device data indicative of a plurality social profiles associated with users of the others of the plurality of authenticated wireless communication devices for display on the display of the authenticated wireless communication device.

27. The system of claim 21 wherein the social profile determination module is further configured to send data indicative of the determined social profile for the user of the authenticated wireless communication device to others of the plurality of authenticated wireless communication devices for display on a display of the other of the plurality of authenticated wireless communication devices.

28. The system of claim 21 wherein the message data comprises the types of messages sent by the authenticated wireless communication device and the types of messages received by the authenticated wireless communication device during a selected period of time.

29. The system of claim 21 wherein the message data comprises the number and type of messages sent and received by the authenticated wireless communication device, and the number of responses received to messages sent by the authenticated wireless communication device, and the social profile determination module is further configured to weight the social profile dependent on the number of responses received in response to messages sent by the authenticated wireless communication device.

30. The system of claim 29 wherein the social profile determination module is further configured to weight the social profile dependent on the number of recipients in each of the sent and received messages.

31. The system of claim 21 wherein the determined social profile comprises a numerical value on a numerical scale.

32. The system of claim 21 wherein one or more of the plurality of wireless access points are configured to transmit advertising data from the venue to the authenticated wireless communication device via the communication link, the advertising data being based on the determined social profile.
